(19) United States
(12) Patent Application Publication
(10) Pub. No.: US 2022/0268620 A1
(43) Pub. Date: Aug. 25, 2022

(54) CONTAINERIZED TRACKING AND REORDER SYSTEM

(71) Applicant: Jay Schiller, Medina, WA (US)

(72) Inventor: Jay Schiller, Medina, WA (US)

(21) Appl. No.: 17/401,592

(22) Filed: Aug. 13, 2021

Related U.S. Application Data
(60) Provisional application No. 63/152,234, filed on Feb. 22, 2021.

(51) Int. Cl. G01G 19/414; G06Q 10/08; G01F 23/20; G01G 19/64

(52) U.S. Cl. CPC G01G 19/4144; G06Q 10/087; G01F 23/20; G01G 19/64

(57) ABSTRACT

A product container includes sensors and logic that detects a product weight (e.g., detects a total package or container weight and makes adjustments based on known weights of the package or container alone) and communicates the weight to a user's device. An indication may be provided that the product weight has fallen below a set threshold value for reordering, and the user may be prompted to reorder the product. The user may electronically reorder the product or a similar product from their device using one or more software applications.

### CROSS-REFERENCE TO RELATED APPLICATIONS

This application claims priority and benefit under 35 USC 119(e) to U.S. application Ser. No. 63/152,234, titled “WEIGHT SENSING CLOSED LOOP SYSTEM” filed on Feb. 22, 2021, the contents of which are incorporated herein by reference in their entirety.

### BACKGROUND

Modern consumer computing devices such as mobile phones include wireless cellular, WIFI, Bluetooth and BLE (Bluetooth Low Energy) and other wireless data transmission standards and protocols built in. Internet-connected and near field wireless communication is proliferating in homes and businesses along with IoT (Internet of Things) devices, with the mobile phone being the main consumer endpoint along with smart speakers such as Amazon® Alexa®, as well as cloud computing and IOT connectivity platforms such as Amazon Web Services (AWS), Microsoft Azure, and Particle (www.particle.io). IoT data communications networks and technologies like Zigbee, LTE-M, NB-IOT, Beacon protocols layered on top on BLE signals allow multiple IoT devices in a home or office to communicate with a mobile or other consumer application in the homes and over the Internet. This new technology opens the door to closed loop systems that improve the convenience of maintaining resources in the home or office or factory or warehouse.

### BRIEF SUMMARY

A system is disclosed that senses, measures and wirelessly transmits one or more readings representing a product's weight (which herein includes representative values such as mass or gravitational force) to one or more users' mobile devices (for example, iPhone) or other computer systems. The measured weight of a product (for example, milk, dog food, propane, etc.) may be displayed on the mobile device numerically or graphically in units such as, for example, pounds and/or kilograms, and/or may be a percentage and/or graphical representation of the products remaining weight with respect to its original full weight (which may be when purchased). Alternatively or additionally, an indication may be provided that the product weight has fallen below a set threshold value for reordering. One or more applications operating on the mobile devices and/or a server system compares the measured weight with the original full weight in order to calculate the portion or percent consumed and/or alert relative fullness or emptiness. The user may electronically repurchase the product from their device using one or more software applications.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a system 100 in accordance with one embodiment.

FIG. 2A depicts a propane tank arrangement in accordance with one embodiment.

FIG. 2B depicts the propane tank arrangement in additional aspects.

FIG. 3 depicts one embodiment of a product reorder process 300.

FIG. 4 depicts another embodiment of a product reorder process 400.

FIG. 5 depicts a weight determination process 500 in accordance with one embodiment.

FIG. 6 depicts a product reordering process 600 in accordance with one embodiment.

FIG. 7A depicts a tracking and reordering system machine interface 700 in accordance with one embodiment.

FIG. 7B depicts the tracking and reordering system machine interface 700 in additional aspects.

FIG. 7C depicts the tracking and reordering system machine interface 700 in additional aspects.

FIG. 8A-FIG. 8C and FIG. 9 depict inverse tare calibration in accordance with one embodiment.

FIG. 10A-FIG. 10C depict an app interface in accordance with one embodiment.

FIG. 11A-FIG. 11C depict consumption tracking in various embodiments.

FIG. 12 depicts a weight change adjustment in accordance with one embodiment.

FIG. 13 depicts an embodiment of a system for automated inventory management, utilizing embodiments of the apparatuses and techniques disclosed herein.

FIG. 14 depicts a client server network configuration 1400 in accordance with one embodiment.

FIG. 15 depicts a mobile device 1500 in accordance with one embodiment.

FIG. 16 depicts an exemplary computing device 1600 that may incorporate embodiments of the present invention.

FIG. 17 depicts a machine 1700 in the form of a computer system within which a set of instructions may be executed for causing the machine to perform any one or more of the methodologies discussed herein, according to an example embodiment.

### DETAILED DESCRIPTION

Embodiments are disclosed for tracking the level of products in multiple containers and providing a closed-loop resource management system, such that resource levels in the containers are maintained above configured levels. The systems include a sensor arrangement such that weight sensing is provided for each individual container. The system also utilized at least one motion sensor, which may be configured to detect the presence of a person (e.g., commercial motion sensors specifically for the purpose of detecting objects with human characteristics). The motion sensor more generally is any sensor that detects movement or vibration either in the vicinity of the containers, or of the containers themselves, or of a lid on particular containers. Each container may in some cases comprise its own motion sensor, or the (one or more) motion sensor may be separate from the containers, meaning for example mounted on the ceiling, wall, or shelf for example in the area of the containers.

The system includes control settings that correlate each container to an identify of a product in the container to determine corresponding containers for each product. The system further tracks an amount of each product remaining in each corresponding container based on an output of the weight sensor for the corresponding container. An app or application of a user device provides a control interface comprising tracking controls for each product, each tracking control including a level indication and a reorder control for the product of the corresponding container. The system selectively activates, on the control interface, the reorder control of one or more of the products, on condition that a level of the product as indicated by the level indication of the product satisfies a threshold level configured for the product. Additionally, the system suppresses activation of the reorder controls based on the output of the motion sensor. Specifically, in one embodiment, the system enables and/or automatically activates a reorder of the product on condition that the output of the motion sensor meets or exceeds a configured motion threshold, that is, that a sufficiently high-level of motion is detected in the vicinity of the container, or (in another embodiment), indicates a threshold of motion of a lid of the container.

When the motion sensor is a vibration sensor, or if the system includes separate vibration sensor(s), it may suppress an update to the level of the product on condition that an output of the vibration sensor does not satisfy a configured vibration threshold.

The system may included, as control settings, a configured unit weight for each product, and may track an amount of each product by applying the configured unit weight for each product to convert the output of the weight sensor to a change in unit count for the product.

In a specific embodiment, at least one of the containers is a propane tank.

The containers of the system may have an integral base unit to detect the weight of the contained resources, or the base unit may be separate such that the container may be lifted or otherwise conveniently separated from it.

More specifically, activation of the reorder controls may be based on a condition that the motion sensor does not detect motion of a person in the location of the containers, and/or that the (one or more) motion sensor does not detect removal of a lid of the container. An example of a motion sensor that may be included on each container is an infrared motion sensor, and an example of a sensor that may detect motion or removal of the lid is an electrical contact sensor.

A container for use in such systems may include a weight sensor, a motion sensor, and a product identifier for a product in the container. The container, for example in an integral or separable base unit, may include logic to detect a changed weight of the product indicated by the weight sensor. On condition that the output of the motion sensor does not satisfy a configured motion level, the container may associate an existing recorded weight of the product in the container to the changed weight, otherwise it may communicate to an app or application of a user device an indication of the changed weight.

The container may also include a vibration sensor (the motion sensor, or a distinct sensor for detecting vibration). The indication of changed weight may be communicated to the app or application on condition that an output of a vibration sensor satisfies a configured vibration level.

The container may be configured with a unit weight for the product it contains, and may include logic to convert the changed weight to a change in a unit count for the product, where the indication of the changed weight for the product is the change to the unit count.

As noted, the motion sensor may be a sensor to detect manipulation of a lid of the container.

The indication of the changed weight may also comprise a change in a total weight of the product in the container.

The container may include logic to associate the existing recorded weight of the product in the container to the changed weight on condition that the output of the motion sensor satisfies a configured duration as well.

The one or more weight sensor components, which may be piezo resistive strain gauge or load cell sensors, may be electrically connected to one or more electronic circuit modules for the purpose of remotely measuring a product's weight and/or proportion and/or units and/or time remaining from a product's full original weight so that a consumer may know to repurchase or refill the product before it's empty, for instance. For example, if a bag of dog food weighs ten pounds when purchased and half is consumed then the proportion remaining from the full original weight is 50%, or half. It should be understood throughout that detecting or measuring a “product weight” may involve measuring a total package or container weight, including the product, and making adjustments based on known empty weights of the package or container alone, which may be carried out in the weighting module itself or by an external device such as a mobile phone or server that applies known empty package or container weights to make the adjustments. In other cases it may be sufficient to just measure the original weight of the full container or package and it's weight at a later time after some product has been depleted from it, since the empty container/package weight is a constant that may be eliminated by subtracting the two weight measurements.

In one implementation, the weight sensor components and electronic circuit modules are, at least one of, integrated into, embedded in, placed inside, and attached to a product's packaging. A product may be packaged in bag, box, carton, jar, etc. as commonly found at a store.

In another implementation, the weight sensor components and electronic circuit modules are, at least one of, integrated into, embedded in, placed inside, and attached to a separate container within which a product is placed. A product without packaging may be placed inside a separate container, such as, for example, milk in a carafe. In another use, the product in its packaging may be placed in the separate container, such as, for examples, a carton of milk in a milk box or a tray placed under a carton of milk in a refrigerator.

In yet another implementation, the weight sensor components and electronic circuit modules are, at least one of, integrated into, embedded in, placed inside, and attached to a unit separate from and detached from the product container or packaging, e.g., a smart shelf or stand for the product package or container.

There may be just one weight sensor component with each product packaging or each container, for example, which may be on the bottom so that when the product is resting with its bottom on a surface the sensor can detect the weight or force between the product and the surface. There may be two weight sensor components with each product packaging or each container, for example, with one on top and one the bottom so that the weight or force can be sensed when so that when the product is resting with its bottom or its top (e.g. upside down) on a surface the sensor can detect the weight or force between the product and the surface. There may be six weight sensor components with each product packaging or each container, for example, with one on top and one the bottom and one on each of the sides so that when the product is resting with its bottom, top, or any of its sides on a surface the sensor can detect the weight or force between the product and the surface.

As understood by those skilled in the art, each of the one or more weight sensor components' electrical resistances varies by an amount that correlates with an amount of external weight, force, pressure, and/or tension applied to each. The one or more electronic circuit modules may convert each of the weight sensor component's resistances to analog voltages and each analog voltage to one or more digital voltage data values. There may be one digital voltage data value output for each weight sensor component and/or there may be one digital voltage data value output for a plurality of weight sensor components corresponding with their collective resistances and analog voltages. In order to convert resistances to analog voltages and to convert analog voltages to one or more digital voltage data values, the one or more electronic circuit modules may each include one or more Wheatstone bridges, operational amplifiers, resistors, capacitors, low pass filters, analog to digital converters, microcontrollers, memory, power supplies, batteries, and/or other electronic components as known and arranged by those skilled in the art.

Herein the digital voltage data values are also referred to as digital weight data values or just weight readings. The one or more electronic circuit modules may store the digital weight data values in memory. This system may further include one or more environment sensors that may be electrically connected to the one or more electronic circuit modules. The one or more environment sensors may be at least one of gyros, accelerometers, GPS, temperature sensors, altimeters, magnetometers, proximity sensors, optical, battery level sensors, and/or other types of sensors. The electronic circuit modules convert each of the environment sensors measures to digital ‘environment data’ values by using electronic components arranged in one or more circuits as known by those skilled in the art. The one or more environment sensors may be at least one of integrated in the electronic circuit module, and integrated into, embedded in, placed inside, and attached to a product's packaging. In another implementation, the one or more environment sensors may be at least one of integrated in the electronic circuit module, and integrated into, embedded in, placed inside, and attached to a container within which a product is placed. The one or more electronic circuit modules may store one or more environment data values from one or more environment sensors in memory.

The one or more electronic circuit modules may include wireless data communications technology by using electronic components arranged in one or more circuits as known by those skilled in the art. The data communication technology may be wireless cellular data, Zigbee, or Bluetooth Low Energy (BLE) RF technology and beacon protocols (which may be for example Apple iBeacon), for transmitting and receiving data. The weight sensor (or associated logic) for example may be a Bluetooth SMART device, and the user device that communicates with the weight sensor (or associated logic) would be Bluetooth SMART READY. Another wireless technology that may be utilized between the product container and the user's device is ANT+ and another if WIFI. Cellular LTE, 4G, or 5G wireless networking and other data communications technologies may also be utilized. Yet another wireless technology that may be utilized is Long Range Wide Area Networks (LoRaWAN).

The weight sensor (or associated logic) for example may be a Bluetooth SMART device, and the user device that communicates with the weight sensor (or associated logic) would be Bluetooth SMART READY. Another wireless technology that may be utilized between the product container and the user's device is ANT+.

Using data communications, the one or more electronic circuit modules may transmit at least one of digital weight data values, environment data values, and other data stored in the electronic circuit module's memory. The other data may include at least one of identity data and product data.

At least one of digital weight data values, environment data values, and other data may be received remotely via data communications by one or more software applications on at least one of one or more mobile devices (which may for example be and Apple iPhone smartphone), one or more human operated computer systems, and one or more artificial intelligence (AI) computer systems. The computer systems may be cloud computer systems as known by those skilled in the art. The mobile devices, and human and AI computer systems may communicate via data communications with the electronic circuit modules over at least one of the Internet, wireless which may be cellular data, BLE or WIFI, and other means, including emerging satellite data networks, and a combination of means.

The software applications may use one or more software algorithms to calculate one or more products' weights from the digital weight data value and/or one or more products' proportion remaining from the full original weight by comparing the original weight with the calculated weight from the digital weight data value. For example, if a bag of dog food weighs ten pounds when purchased and half is consumed then the proportion remaining from the full original weight is 50% or half. The one or more software applications may receive one or more digital weight data values it receives for the one or more weight sensor components for each product.

Each weight sensor component may be uniquely identified in the algorithm by a unique ID from identity data and associated with a product by its product data sent from at least one of one or more electronic circuit modules and one or more Internet cloud hosted databases. The product data may include the full original weight of the product in a particular package configuration. The one or more software algorithms may use one or more digital weight data values to calculate the current weights of one or more products. The one or more software algorithms may use one or more digital weight data values to calculate the proportion remaining of one or more products by comparing the current weights with each product's full original weight. The algorithm may be implemented in an application on a mobile device and/or may be on a cloud-based computer and/or AI system communicating with the application on the mobile device over the Internet. Instead of reading the full weight from an Internet database, when the product contents of the container are filled by a user, the user may press a button (the “full button) on the container which in turn signals to the software application that it should record the current weight as the full weight level. The full button may additionally or alternatively be implemented in software on the application user interface. The container may also include a zero (or tare) button for calibrating the zero point of an empty container as those familiar in the art of digital scales are familiar. The tare button may additionally or alternatively be on the application user interface. Embodiments implemented as a container for the product may or may not utilize an accelerometer. In some embodiments, a gyroscope may be utilized in the container to detect tilt to suppress the taking of measurements. In some embodiments, a gyroscope may be combined with an accelerometer to detect tilt and motion both, to suppress the taking of measurements under these circumstances.

In some implementations, the application may be configured for either volume, unit or time based measurement for the maximum weight value and the reorder threshold values or a product. The application may track one or more containers with each configured independently for volume, unit or time measurement depending on the product. For example, with two containers tracked by the application, the first container (“container 1”) could be used for coffee beans and configured for volume measurement whereases the second container (“container 2”) could be used for Nespresso coffee capsules and configured for unit measurement. The application would display percent remaining for container 1 and the reorder threshold level would be a percentage full, but for container 2, the application would display the number of capsules (i.e., units of product) remaining based on the measured weight of the container contents divided by the unit weight of an individual capsule (i.e., the product). For container 2, the reorder threshold may be set as a number of capsules instead of a percentage. The product unit weight (e.g., one capsule) could be entered by the user or read (from a database in the cloud or over the data network) based on a barcode scan or other common identification method.

In yet another implementation of the application, the containers may be configured as time measurement and indicate how many months, days, hours or other units of time remains for the measured product supply based on consumption pace either entered manually or based on historical patterns. The application would display the time (e.g., six days) remaining until the product supply is fully consumed and the reorder threshold level could be set in terms of time units instead of percentage or units (e.g., capsules) remaining.

Embodiments implemented as a container for the product may or may not utilize an accelerometer. In some embodiments, a gyroscope may be utilized in the container to detect tilt to suppress the taking of measurements. In some embodiments, a gyroscope may be combined with an accelerometer to detect tilt and motion both, to suppress the taking of measurements under these circumstances.

In some embodiments, the weighing module may be detachable such that it may be moved from one container to another, and/or for charging the electronics without having to move the container with it, or for sale and/or distribution of the container and module separately. One of the container or module or both may have detachable fastening mechanisms, many varieties of which are known in the art, for this purpose. For some applications, such as propane tanks, the weighing module may include an interface to a solar charger. In other applications the module may utilize near-field charging to wireless recharge the batteries for the electronics.

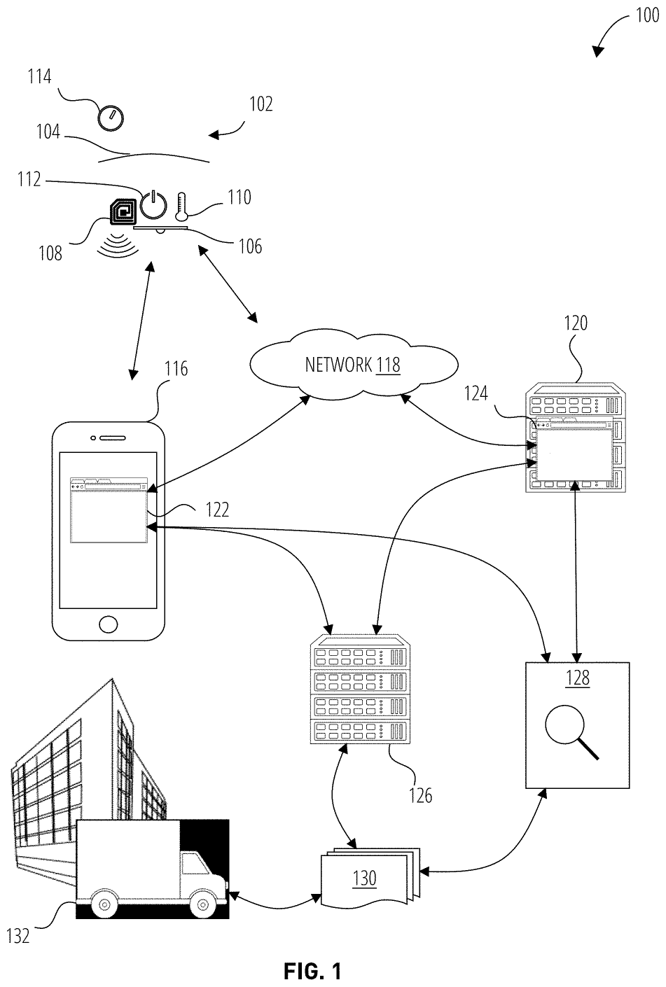

Referring to FIG. 1, a system 100 comprises a product container 102 that contains a product 104. The product container 102 comprises a weight sensor 106 and logic 108 interfaced to accept readings from the weight sensor 106. The product container 102 may also comprise other sensors, such as a temperature sensor 110 and an accelerometer 112 and/or gyroscope 114.

An example weight sensor 106 is a Tekscan FlexiForce A401 integrated into, embedded within or attached to a product's packaging or the container base. This type of sensor element changes one or more of its electrical properties such as, for example, resistance or voltage (if powered) when it undergoes a force, pressure, stress, and/or strain due to the product's weight. Metal load cell weight sensors change their electrical resistance when then undergo mechanical strain relative to the weight of the product. The sensor element's electrical property state corresponds with the product's weight when it is placed between the product and the ground, shelf or another surface. The sensor element may be a load cell, load bar, piezoelectric, piezoresistive, pressure transducer, strain gauge, force gauge, fiber optic, or other types. One or more weight sensors may be used in the base of the container, similar to a digital kitchen food scales which often have four load cell weight sensors electrically connected and operating as one.

The system 100 may include logic to convert the sensor's raw electrical output, corresponding to a product's weight, to a digital “weight data” value. This logic may be part of the weight sensor 106 and/or included in the logic 108, or in the user device 116. The weight sensor 106 may use an analog to digital converter (ADC) to convert an analog electrical property to a digital weight data value. For example, the weight sensor 106 may include a Avia Semiconductor HX-711 ADC instrumentation amplifier or a Texas Instruments ADS7868IDBVR ADC integrated circuit chip. For example, a piezoresistive or load cell sensor element's electrical resistance value changes as a function of a product's weight when placed between the product and a surface, similar to, for example, a weight scale. The piezoresistive or load cell sensor element, in this example, may be attached to a Wheatsone bridge to connect other weight sensors together to collectively act as one and a power supply in the sensor logic which together convert the sensor element resistance to an analog voltage level which corresponds with the product's weight. The ADC converts the analog voltage to a digital weight data value that may be, for example, 8-bit or 10-bit binary numbers.

The weight sensor 106 may include one or more instrumentation amplifiers, low pass filters, and other electronic componentry before the ADC to condition the signal, and one or more other electronic components after the ADC, and one or more other electronic components in general. The weight sensor 106 may include one or more Wheatstone bridges, operational amplifiers, instrumentation amplifiers, low pass filters, analog to digital converters, transistor, LEDs, lasers, microcontrollers, microprocessors, software code, firmware code, accelerometers, gyroscopes, temperature sensors, GPS, buttons and switches, encryption/decryption and authentication capabilities, memory, printed circuit board, resistors, capacitors, inductors, power supply, voltage regulators, batteries, wires, connectors, battery chargers, battery level indicators, solar cells, Internet of Things (IoT) technologies, calibration, data modems, antennas and more. Again, these may be part of the weight sensor 106, and/or included in the logic 108 separately from the weight sensor 106. Again, these parts and/or the weight sensor may be embedded in the product packaging and/or in the container separate from the product placed in the container.

The weight sensor 106 may include or couple to wireless technology (e.g., the logic 108) for transmitting the weight data and other data to one or more mobile devices and/or other computer systems, such as the user device 116 or network 118. The weight sensor 106 may include or couple to wireless technology for receiving data from one or more mobile devices and/or other computer systems and one or more software applications operation on such mobile devices and/or computer systems. Note that other electronic components may be present as understood in the art, such as a battery or capacitor based power supply and a digital memory and a data processor.

Generally, the weight sensor 106 communicates either directly or indirectly to a mobile device or server system 120 via one or more of Bluetooth, BLE or WIFI, and/or over the Internet (remotely or locally) over WIFI, cellular data, or a combination of these technologies. Mobile phones for example include cellular data and WIFI modems, and Bluetooth and BLE technology and protocols built in. Yet another wireless technology that may be utilized is Long Range Wide Area Networks (LoRaWAN).

Wireless cellular data networks exist specifically for use with Internet of Things (IoT) devices and cloud development platforms for hosting the backend application and data. A phone app for example may communicate with the backend application over the Internet via its data modem or WIFI. The backend application may communicate with the IoT devices over the Internet/WIFI or over the IoT wireless cellular data network. The modem chips for IoT devices are typically capable of multiple ways to communicate cellular data, WIFI, Bluetooth, and other wireless technologies (e.g., LoRaWAN).

The logic 108 (which as noted above may be part of the weight sensor 106) communicates wirelessly with a user device 116 such as a mobile phone, tablet computer, smart appliance, connected speaker like Amazon® Alexa®, game console, laptop computer, etc. The logic 108 may also communicate wireless with the network 118 which in turn may communicate with the user device 116. The user device 116 executes a user device application 122, and communicates with a server system 120 over a network 118 such as a home WIFI network, cellular network, or the Internet or a combination. The logic 108 may also, or alternatively, communicate directly with a server system 120 over a network 118 such as a home WIFI network, cellular network, or the Internet or a combination. The server system 120 executes a server application 124 which interfaces (again, usually via the network 118) with an ecommerce system 126 and/or a search engine 128. The system 100 further includes vendor products 130 accessible via the search engine 128 and/or ecommerce system 126, and a fulfillment service 132 for making delivery of products ordered via the ecommerce system 126.

Examples of environment data include but are not limited to ambient temperature, humidity, atmospheric pressure, altitude, acceleration, battery level, velocity, location, and/or more. The logic 108 may further wirelessly receive, store, act on, and wirelessly respond to “configuration and command data” which may include test commands, calibration commands, status requests, technical health status, error messages, acknowledgment responses, and software and firmware installations and updates.

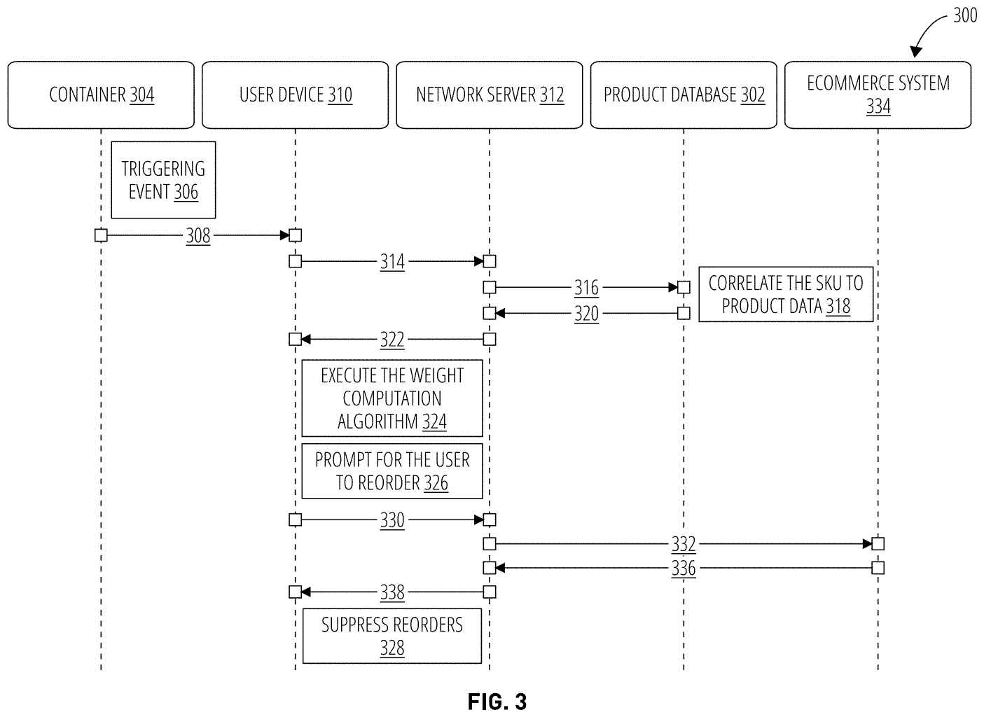

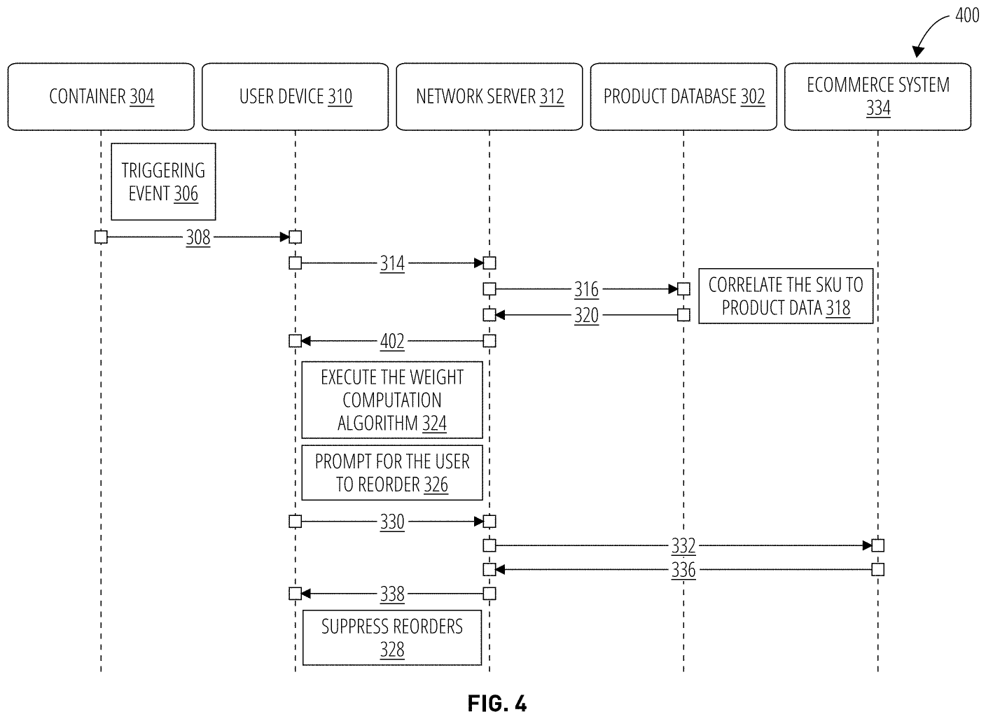

Examples of product data include but are not limited to full weight when originally packaged, product name (e.g. milk), brand, UPC (Universal Product Code), EAN (International Article Number), manufacturer part number, SKU (stock keeping unit), safe food storage temperature ranges, web site addresses, and other product information and identifiers. The examples in FIG. 3 and FIG. 4 illustrate the SKU as the product identifier, but other embodiments could employ one or more other product identifiers, for example from among those indicated above (e.g., UPC, EAN . . . ).

One or more sensors described herein may be attached to the product container 102 by consumers and/or middlemen before, at or after the point of sale to the consumer. The sensor(s) may be built into stickers with adhesive to be stuck to the product packaging. The sensor(s) may be provided to the consumer at, before or after checkout at a store, for example, and attached to the product container 102 at the point of sale, and/or after the point of sale. The sensor(s) may be attached by people, machines and/or robots. Manufactures may attach the sensor(s) to the bottom of the product container 102 on the inside before putting the product 104 into the product container 102. The sensor(s) may be integrated into, embedded within, or attached to separate containers within which product 104 is placed inside or placed on top. One type of container may be a flat surface on which a product 104 rests and another type may be a box with or without a lid that the product 104 can be placed into. The consumer may reuse and may reassign the product container 102 to different products. The stickers may be reusable and may be reassigned.

The illustrated examples show the product data being stored on a network device such as product database 302 (see FIG. 3), and accessed by association with a product ID (e.g., SKU) received from the product container 102. However, some embodiments may store the product data in the logic 108 of the product container 102.

In one scenario, the user device application 122 may assign product data to the product container 102 (or if sold separately from the product container 102, the weight sensor 106 and/or associated logic 108) by first optically scanning the bar code image on the product container 102 with the user device 116 to get the UPC, SKU, or other code value, and second, using the this value to lookup the product data in one or more Internet databases such as the product database 302. The product data may include the unit weight. In another scenario, the user device application 122 may associate the product data by retrieving from a store check-out cash register bar code scanner system's database. In yet another scenario, the user device application 122 may receive the “product data” directly from the product container 102 in cases where the product data was previously stored in memory of the logic 108. In even yet another scenario, a user may manually enter product data into the product 104 and assign it to each weight sensor 106 and/or product container 102. Alternatives to UPC images and codes may be QR codes and images, and RFIDs, near field communications, and other systems may be used for scanning the product container 102 for looking up product data on the Internet. At least one of receiving the product data from the logic 108, retrieving it from an Internet database such as product database 302, based on an optical product package scan (UPC bar code for example), retrieving it from the store check-out cash register bar code scanner system's database, and manual entry may be used to associate product data for one or more product container 102, product 104, and one or more sensors such as weight sensor 106, or logic 108.

The user device application 122 may be a software development kit (SDK) that 3rd-party applications may integrate. For example, a grocery store may have mobile phone application that provides uses with coupons, loyalty card information, mobile shopping delivery and pick-up services, as feature examples. The grocery store mobile application may incorporate the user device application 122 in the form of an SDK.

The user device application 122 may do more than prompt the user to reorder a product 104 that's reached a low “reorder threshold” level. The user device application 122 may graphically display the weight level relative to full level. For illustrative purposed, for example, the graphic may look like a gas gauge with a needle positioned between full and empty. The user device application 122 may display a weight in weight units, such as, for example pounds. The user device 116 may display a percentage full and may alert the user with for example, sounds, notifications, e-mail, appearance/enablement of purchase (“buy”) controls, and/or colors when the level remaining is at or below a certain threshold level. The user may set the reorder threshold level in which they want to be notified that they should reorder the product to refill the container. The reorder threshold level may be a percentage of full, for example 20%. Alternatively, the reorder threshold and the displayed levels may by the number of units for products such as Nespresso coffee capsules. The number of units may be calculated by the application algorithm by dividing the total product weight in the container by the weight of a single unit of the product. The user device application 122 may use environment data, for example temperature, received from the product container 102 and compare it to safety data in the product data, for example safe temperatures, to alert on unsafe storage conditions such as, for example, if the product 104 is not properly refrigerated for an unsafe period of time.

In some embodiments, the user doesn't set the reorder threshold and instead the threshold is inferred from the user's profile or behavior, i.e., its time based. The user device application 122 may collect and send users' product consumption data, and may send environment data, to a software service on the Internet to predict when to reorder one or more products based on user data and/or other data that may include pace of consumption, product lead and delivery times, seasonality, storage temperature patterns, and/or other considerations. The application alert notifications may include recommendations such as when to reorder, alternative products, alternative retailers, recipes, and/or more.

The user device application 122 may allow a user to enter electronic commerce details and authentication information to reorder (such as, for example, on Amazon), payment details, notification and alert settings (e.g. email), and more. The user device application 122 may allow products to be monitored and reordered direct to suppliers' ERP, CRM, and other inventory and procurement technologies. The search engine 128 may provide the user with product offers from one or more digital e-commerce and/or physical retail stores. These offers are search engine results and recommendations may show different digital and/or physical retailers' offers and/or prices for the same products being measured and/or products that are like the ones being measured. The search results may include images, location, web links, prices, options, reviews, and more.

The user device application 122 may communicate over the Internet or other network to the server application 124 that manage the user device application 122, authenticates, and allows for user input and displays information to users. The server system 120 may host and the server application 124 may use one or more third-party software as a service (SaaS) providers one or more database, machine learning algorithms and platforms, security, authentication, payment, financial, and may connect with product search engines, e-commerce systems, payment systems, crypto-currency systems, fulfillment services, user app management and update systems and marketplaces (e.g. Apple), search engines, vendor CRM and ERP systems, and more.

The weight sensor 106 may communicate over the Internet or other network to the server application 124 that manage the user device application 122, authenticates, and allows for user input and displays information to users. The server system 120 may host and the server application 124 may use one or more third-party software as a service (SaaS) providers one or more database, machine learning algorithms and platforms, security, authentication, payment, financial, and may connect with product search engines, e-commerce systems, payment systems, crypto-currency systems, fulfillment services, user app management and update systems and marketplaces (e.g. Apple), search engines, vendor CRM and ERP systems, and more.

The user device application 122 may be used to scan a bar code, QR code, packaging image, or RFI tag on the product which can be used by the user device application 122 to look up the full capacity, weight, etc. and/or empty capacity, weight, etc. of the product in a database (e.g. product database 302) in the server application 124. The user may be able to manually enter the full amount into the user device application 122. The user may be able to enter a threshold level into the user device application 122 at which to notify them that it's time to repurchase the product 104 or to automatically place the order.

The server application 124 may predict when the product 104 will run out based on consumption pace and may use machine learning algorithms to predict future levels and purchase timing and dates. The user device application 122 notifies the user when it's time to repurchase the product 104 when it reaches the reorder threshold level. The reorder threshold level can be set manually by the user (absolute amount or percent) or the user device application 122 can provide a default level or amount or percent full. The threshold may be determined by the machine learning algorithm such the user is notified to order the product 104 at a time when it predicts will allow for the ecommerce system 126 (e.g. Amazon.com, Walmart.com, etc.) to process the order and fulfill its delivery or in-store pick-up using the fulfillment service 132.

The user device application 122 may trigger the product order automatically if the user chooses or may require the user's explicit ‘purchase’ action. The user may set and/or select one or more e-commerce services which may include payment details (e.g. credit card, Pay Pal, Apple Pay, etc.) and/or e-commerce service account credentials and/or the user's home or other physical location details into the user device application 122 for ordering and re-ordering products from the ecommerce system 126. The ecommerce system 126 may fulfill the product order directly by shipping the product to the user or may request that a third party seller (e.g., fulfillment service 132) ship the product to the users or may arrange for the user to pick the product up at a physical store or locker location.

The user device application 122 may present the user with alternatives options from which to purchase the product 104 from vendors offering deals online and/or in physical retail locations. The user device application 122 may communicate with the server application 124 which may include (via an application program interface (API)) one or more product search and/or discovery engines (e.g. Search engine 128—Amazon, Google, etc.) that automatically via one or more search algorithms and web crawlers discover and/or identify offers from one or more vendors. In some cases, one or more vendors may provide (or push) offers via a product data feed or manual entry into the one or more search engines.

Alternatively, the user device application 122 may communicate directly with the search engine 128 and not go through the server application 124. The search engine results are sent to the user app after the weight sensor 106 detects the product 104 is at or nearing or past the threshold level. When the sensor measurement reaches the threshold the user device application 122 may notify the user that it's time to re-order the product 104 and may present one or more search results with offers to purchase the product 104 which allows the user to compare pricing and/or vendor options which may be local and/or online retailers. These may be ecommerce vendors (i.e. services) or physical stores (e.g. Pets Mart) with or without ecommerce. This arrangement connects the search engine 128 with physical sensor measurement at the user (i.e. consumer) level.

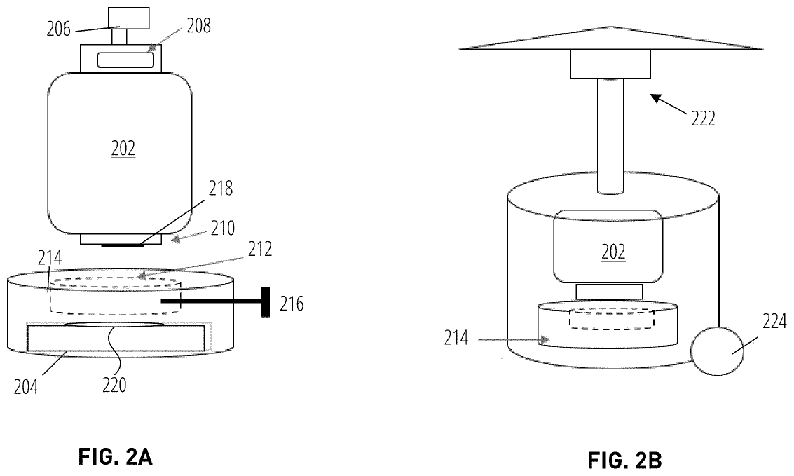

FIG. 2A and FIG. 2B depict an embodiment of a system comprising a propane tank 202 and a sensing system 204. The sensing system may comprise the capabilities and functions described for the product container 102 including the weight sensor 106, and its data communications with user device 116 and system 100, and some or all of the aforementioned functions and configurations. The propane and/or propane tank is the product in this case. The propane tank 202 dispenses propane through a valve 206 and can be moved for restocking with propane using a carry handle 208. A tank base 210 engages with a base receptacle 212 of a stand 214 in which the propane tank 202 is retained by a base retainer 216. The stand 214 comprises a sensing system 204 disposed below the base receptacle 212 to measure, track, and alert a propane reordering system based on the weight of the propane tank 202.

A code or near field device 218 may be located where the tank base 210 contacts or comes into close proximity with the reader 220 of the sensing system 204. More generally, the code or near field device 218 may be located where any product package or container contacts or aligns with the reader 220 of the sensing system 204 (e.g., particular locations on a “smart shelf” comprising multiple sensing systems 204 for different product positions on the shelf).

The code or near field device 218 may for example comprise a QR code, bar code, or passive near-field device (e.g., an RFID) and may be affixed to a bottom location of a container or package for a product (“bottom” meaning a surface upon which the container or package rests under force of gravity). The code or near field device 218 may be positioned in alignment with a code reader or NF reader (the reader 220), respectively, on an underlying support comprising the sensing system 204. The server application 124 and or device application 122 may autoconfigure with information read from the code or near field device 218 about the product that it is affixed to. Such information may include a product id, container weight, reorder weight, approved vendor, location of the product or container in a facility, and so on. Reading of the product information from the code or near field device 218 may be triggered by motion when the container or package is brought into proximity with the reader 220. In some embodiments the code or near field device 218 may encode a product id and/or SKU that is utilized to look up information about the product such as its full container/package weight, configured reorder triggering levels, approved vendors, location in a facility, and so on.

Although depicted as part of a stand 214 that the propane tank 202 rests upon, the sensing system 204 may also be integrated in the valve 206 as a flow sensor, or at the bottom of the propane tank 202 as a weight sensor, or as a weight sensor coupled to a hook or other hanger arrangement suspending the propane tank 202 from the carry handle 208 or other point. As described earlier, a container, stand, or hook configurations may comprise an accelerometer and/or gyroscope to detect motion and tilt dynamics, respectively, and suppress various actions based on those dynamics. For example, if the propane tank 202 is in the base receptacle 212 of a propane heat lamp 222, the system may suppress measurements that take place during motion of the propane heat lamp 222 from one location to another on a patio. In some applications the propane heat lamp 222 may have wheels 224 to enable a person to tilt the propane heat lamp 222 onto the wheels 224 to roll it to another location, dynamics that the gyroscope may detect.

Referring now to FIG. 3, a product reorder process 300 proceeds as follows. A container 304 for a product generates a triggering event 306, for example when the product container 102 is lifted and then set down again (falsely implying some of the product 104 was dispensed). The triggering event 306 causes the container 304 to form and communicate a data packet 308 to the user device 310 or network server 312. Examples of the user device 310 are provided in the discussion of FIG. 1. The data packet 308 may include a product SKU, product identifier, a weight reading (one or more), and environment readings such as temperate and displacement indications (e.g., motion signals from the accelerometer 112 or orientation signals from the gyroscope 114). The user device 310 extracts the product SKU 314 and communicates it to the network server 312, for example via a wireless cellular network, or through a home network through a gateway to the Internet (e.g., see network 118).

In the illustrated embodiment of product reorder process 300, the user device 310 executes the algorithm to determine if the weight of the product in the container 304 has dropped below a reorder threshold for reordering. Thus, the network server 312 receives the product SKU 314 and communicates the product SKU 316 in a query to the product database 302, which applies the product SKU 316 to correlate the SKU to product data 318. The network server 312 receives the product data 320 from the product database 302 and communicates the product data 322 to the user device 310. The user device 310 uses the product data 322 and the weight measurement and optionally the environmental data from the data packet 308 to execute the weight computation algorithm 324. If the computed weight is below a threshold value for the product SKU 314 (the threshold may be included in the product data 322), the user device 310 generates a prompt for the user to reorder 326.

The product reorder process 300 may suppress the triggering event 306, may suppress reorders 328, and/or may not execute the weight computation algorithm 324 if signals from the accelerometer 112 and/or gyroscope 114 indicate the container 304 is in motion and/or tilted to some configured degree (or in the process of being tilted, i.e. the orientation signals are changing in time).

If the user selects to reorder, the user device 310 communicates a reorder SKU 330 message to the network server 312. The network server 312 communicates the reorder SKU 332 to the ecommerce system 334, which places the order for the reorder SKU 332, debits the user's account, and generates a receipt 336 which is communicated back to the network server 312, and from there the receipt 338 is communicated back to the user device 310.

The user device 310 will then suppress reorders 328 for the SKU until a next activation event, so that a next triggering event 306 from the container 304 does not trigger a prompt to reorder the same SKU again. An activation event may be generated by a first activation/interaction of the container 304 with the user device 310 (e.g., if the product SKU of the container 304 is globally unique).

Referring to FIG. 4, another embodiment of a product reorder process 400 is similar to the product reorder process 300, except that the network server 312 is implemented to execute the weight computation system 324. If the computed weight is below a reorder threshold, the network server 312 communicates a reorder signal 402 to the user device 310, and the user device 310 prompts the user in the same manner. The product reorder process 300 or product reorder process 400 may use temperature readings from the environment data for temperature compensation to calibrate the calculated weight associated with digital weight data values since the weight sensor components resistance levels may be affected by temperature, in order to have an accurate measurement. Other techniques may be used to compensate weight sensor components resistance changes in response to temperature including using a dedicated weight sensor components as temperature reference as understood by those skilled in the art. In other implementations, temperature compensation may be implemented in the logic 108.

The system may use temperature data from the environment data to alert a user via the user device application 122 that the product not stored a safe temperature by comparing the temperature data with safe temperature information which may be from the product data. The system may notify the user via the user device application 122 that the state of the product is ‘not safe temperature’ or is ‘safe temperature’.

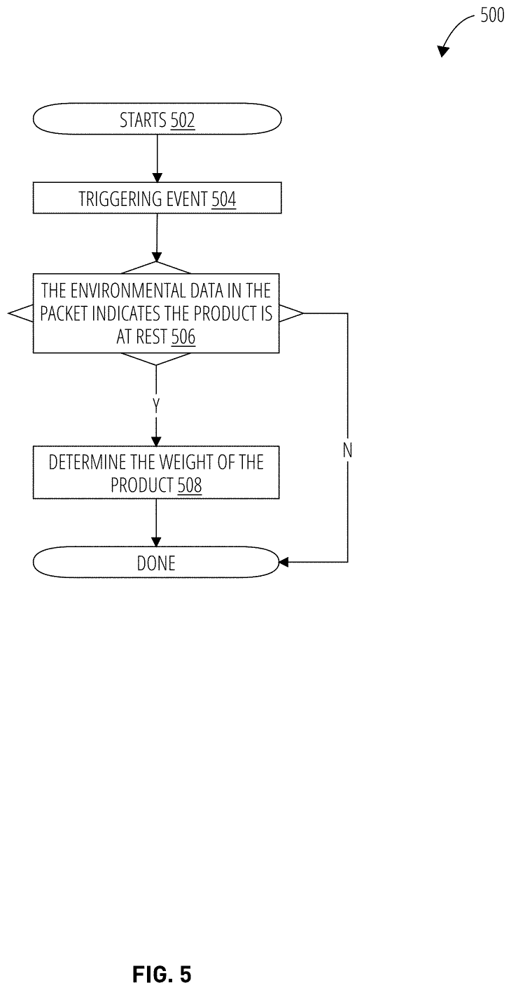

The state of the product may not be conducive to accurate weight readings. The system may take measures to ensure that the product is in a restful state before attempting to determine the weight. Referring to FIG. 5, a weight determination process 500 starts 502 and there's a triggering event 504 that results in an environmental data packet from the product container. If the environmental data in the packet indicates the product is at rest 506, the system will determine the weight of the product 508, otherwise the weight is not determined until a triggering event is received indicating the product has entered a restful state (e.g., the container of the product was set down after being used).

The system may use accelerometer data from the environment data to detect that a product is not at rest on a surface, and in a ‘not at rest’ state and to not perform calculations and/or to instruct the software application to not update the weight status reported to the consumer, as it may not be able to make an accurate measurement. The system may notify the consumer via the user device application 122 that the state of the product is ‘not at rest’. The system may use accelerometer data from the environment data to detect that a container is not at rest on a surface, and in a ‘not at rest’ state and to not perform calculations and/or to instruct the system to not update the weight status reported to the user, as it may not be able to make an accurate measurement. The system may notify the user via the user device application 122 that the state of the container is ‘not at rest’.

The system may use gyro data from the environment data to detect that a product is not at rest on a surface, and in a ‘not at rest’ state and to not perform calculations and/or to instruct the system to not update the weight status reported to the user, as it may not be able to make an accurate measurement. The system may notify the consumer via the user device application 122 that the state of the product is ‘not at rest’. The system may use gyro data from the environment data to detect that a container is not at rest on a surface, and in a ‘not at rest’ state and to not perform calculations and/or to instruct the system to not update the weight status reported to the user, as it may not be able to make an accurate measurement. The system may notify the consumer via the user device application 122 that the state of the container is ‘not at rest’.

The system may use proximity data from the environment data to detect that a product is not in a container, and in a ‘out-of-container’ state, and to not perform calculations and/or to instruct the system of such state. For example, if a container has a piezo resistive strain gauge as its weight sensor component embedded in its bottom, which when combined with a logic 108, is used to sense a carton of milk's weight with the milk carton is at rest in the container, the proximity data may be used by the system to detect cases in which the carton of milk is removed from the container and via the application notify a user of the ‘out-of-container’ state. The container may have at least one of piezo resistive strain gauges, optical, and proximity sensors to sense the ‘out of container’ state when the signal from one or more of these sensors is processed by logic 108 and included in the environment data as proximity data transmitted to the system.

The system may use proximity data from the environment data to detect that a product is not at rest on a surface, and in a ‘not at rest’ state, and to not perform calculations and/or to instruct the software application to not update the weight status reported to the user, as it may not be able to make an accurate weight measurement. For example, if a product package has a piezo resistive strain gauge as its weight sensor component embedded in its bottom, which when combined with a logic 108, is used to sense a carton of milk's weight with the milk carton is at rest on a surface, the proximity data may be used by the system to detect cases in which the carton of milk is removed from the surface and via the application notify a user of the ‘not at rest’ state. The product packaging may have at least one of piezo resistive strain gauges, optical, and proximity sensors to sense the ‘not at rest’ state when the signal from one or more of these sensors is processed by logic 108 and included in the environment data as proximity data transmitted to the system. The system may use proximity data from the environment data to detect that a product is in a container but the container is not at rest on a surface, and in a ‘not at rest’ state, and to not perform calculations and/or to instruct the system to not update the weight status reported to the user, as it may not be able to make an accurate weight measurement. For example, if a product package has a piezo resistive strain gauge as its weight sensor component embedded in its bottom, which when combined with logic 108, is used to sense a carton of milk's weight with the milk carton in a container and the container is at rest on a surface, the proximity data may be used by the system to detect cases in which the container with the carton of milk is removed from the surface and via the application notify a user of the ‘not at rest’ state.

The product packaging may have at least one of piezo resistive strain gauges, optical, and proximity sensors to sense the ‘not at rest’ state when the signal from one or more of these sensors is processed by the logic 108 and included in the environment data as proximity data transmitted to the system.

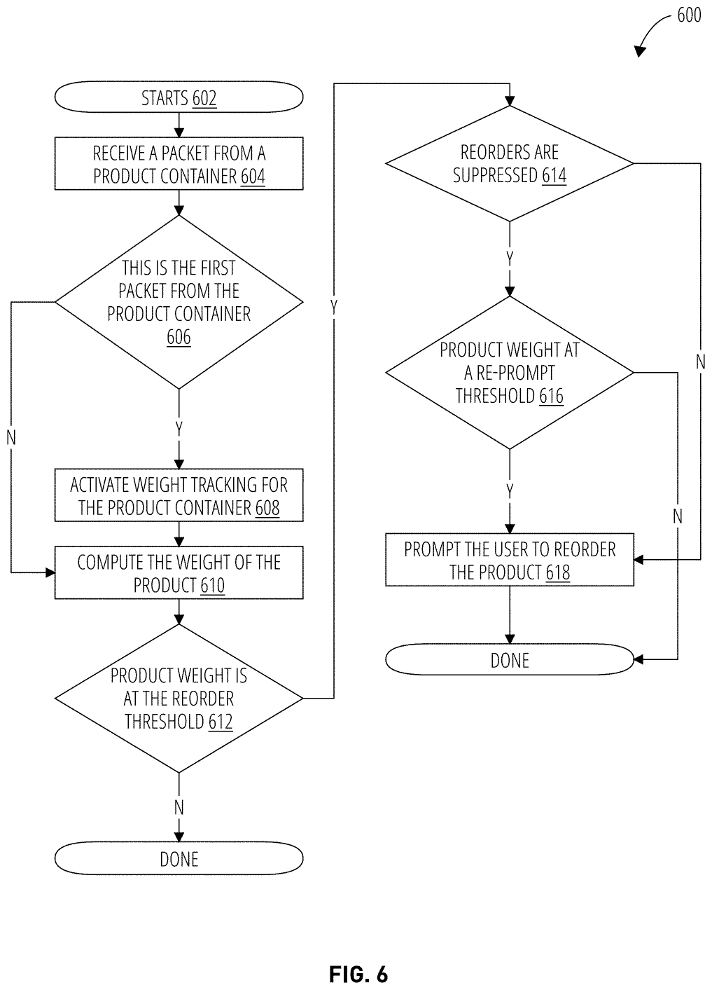

The system may intelligently determine when to prompt the user to reorder the product. Referring now to FIG. 6, a product reordering process 600 comprises starts 602 when there is a triggering event (e.g., see FIG. 3) causing the system to receive a packet from a product container 604. If this is the first packet from the product container 606, the system will activate weight tracking for the product container 608. The system now has the product container in its records for weight tracking and reordering purposes.

The system will now compute the weight of the product 610, as previously described for example, and determine if a product weight is at the reorder threshold 612. If the reorder threshold has been reached, but reorders are suppressed 614, the system checks if the product weight is at a re-prompt threshold 616. If prompting the user to reorder is suppressed, either because the user already reordered, or because the user suppressed prompts until a next lower reorder threshold is reached, then the product reordering process 600 concludes without prompting the user to reorder. Otherwise, the product reordering process 600 will prompt the user to reorder the product 618, at which point the user will either reorder, or select to suppress reordering the product at all, or suppress prompts until a next lower weight threshold is determined.

In a preferred mode of operation, the logic 108 of the container 102 reads an output of the motion sensor (e.g., accelerometer and/or gyro) to determine when the container 102 is in motion. Upon detecting that the container 102 is no longer in motion after being in motion, the logic 108 reads the weight sensor 106 for a weight reading and triggers communication of a data packet using wireless communication logic. The data packet in this preferred mode is formed by the logic 108 to include at least the weight reading and a product identifier.

The user device application 122 receives the data packet and selectively displays an operable control on the user device 116, on condition that a weight of the product 104 as determined from the weight reading is below a threshold level, and further, that the display of the operable control is not suppressed by a prior user response to a prior weight reading for the product. The user device application 122 may apply a temperature reading from the data packet to determine whether to selectively display the operable control (e.g., if the product 104 is nearing an end of fresh life), or has been exposed to unsafe temperatures. In some cases, the temperate reading may override any suppression or threshold settings in place for the product weight, for selective display of the operable control.

Examples of events that can suppress display of the operable control include a prior user response to reorder of the product, to reorder a different product that is analogous, or the user setting a next lower threshold level for the weight reading to trigger display of the operable control.

As noted previously, the threshold level may be set automatically by the system, as a level determined from analyzing a change rate of the weight of the product (user consumption habit).

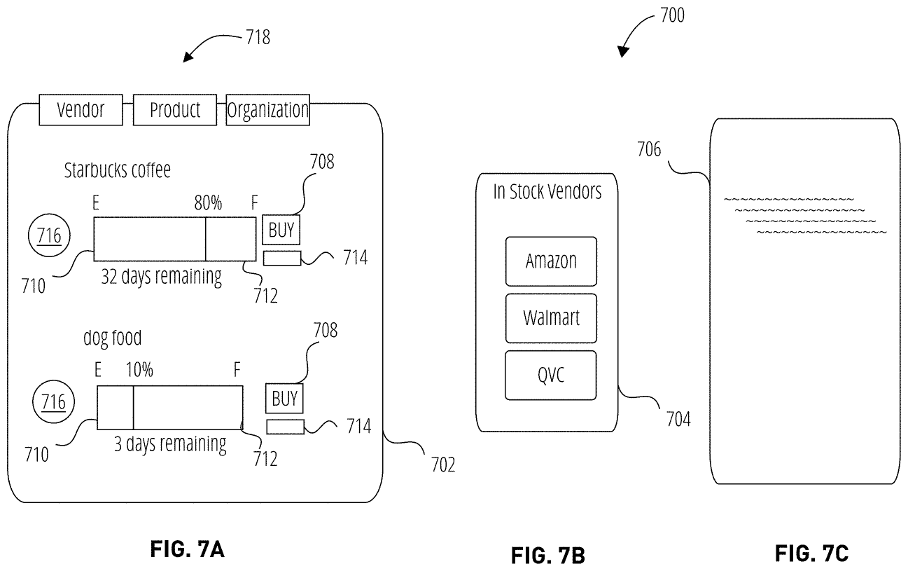

FIG. 7A, FIG. 7B, and FIG. 7C depict an embodiment of a tracking and reordering system machine interface 700 for a device application 122. The tracking and reordering system machine interface 700 includes a tracking interface 702, a vendor interface 704, and a vendor-specific order interface 706. Activation of a particular product's purchase activation control 708 on the tracking interface 702 instantiates the vendor interface 704, providing a list of vendors that have that product in stock for reordering. Selection of one of the vendors from the vendor interface 704 instantiates the vendor-specific order interface 706 for that particular vendor. The vendor-specific order interface 706 may in some embodiments comprise the product page on the vendor's web site for ordering the product.

The tracking interface 702 includes tracking and reorder controls for a plurality of physical products for which the remaining levels are actively tracked, by weight. Although two products are depicted for tracking, there may typically be many more than this, and the tracking interface 702 may be scrollable or have other mechanisms known in the art (e.g., multiple tabs, “Next” controls, etc.) for changing the display to show the tracking of more and different products.

In the depicted embodiment, the tracking interface 702 comprises remaining indicators 710, depleted indicators 712, purchase activation controls 708, and battery level indicators 714, one set for each product being tracked. A full weight setting control 716 is included on the tracking and reordering system machine interface 700 to enable calibration of the application to the full weight of the product. The full weight setting control 716 may be activated when a full product container 102 is bearing on the weight sensor 106. Although depicted on the tracking and reordering system machine interface 700, in other embodiments there may be a full weight setting control 716 (in the form of a touch sensor, screen, or a switch or button) on the product container 102 itself. Those of skill in the art may appreciate that the tracking interface 702 may comprise additional controls and indicators not depicted for this embodiment, and/or a different layout of the depicted controls.

In some embodiments, the purchase activation control 708 may be selectively displayed or enabled in conjunction with certain products on condition that a configured reorder threshold is met, on further condition that a person is sufficient motion is detected in a location of the container, and/or manipulation of a lid of the container is detected. In some implementations, the reorder threshold is set (e.g., on a server system, for an enterprise, or the product supplier) based on a shipping delivery time and the pace of consumption of the product (time rate of depletion of product weight).

When a lid of a container is removed, the manipulation of the lid may be detected as noted above, and any weight change corresponding to a weight of the lid measured by the weight sensor may be attributed the lid being off and ignored in calculations of the change to the product amount in the container. Likewise, when the lid is replaced, the system may recognize that it is not new product being added to the container.

For enterprise-level implementations, the interface may measure and report on multiple containers or packages over a network using one or more central (or distributed) systems that can report the geographical location of particular containers and packages along with the relative level of their contents so that that containers with low (below a configured threshold) levels of product may be refilled or replaced (with a filled) container. Enterprise-level systems may include location indications for the products/containers in a facility/stock room (e.g., on a facility map that is displayed to the system operator). Enterprise-level systems may include content filter controls 718 to enable the selective display of only those products available from particular vendors and their stock levels; selective display of only the same or similar products (e.g., “coffee”) in different locations; and/or selective display of products assigned to or allocated for particular sub-organizations within the enterprise (divisions, teams, groups, etc.). These filters may facilitate the aggregation of reorders of the similar product stock for two or more containers or packages in different locations, with pro rate allocation of the reorder quantity among the containers based on the measured level of product in each; and also facilitate the aggregate reordering of disparate products from a common vendor; and also facilitate tracking and aggregating reorders for a particular group, division, manager, purpose etc. within an enterprise.

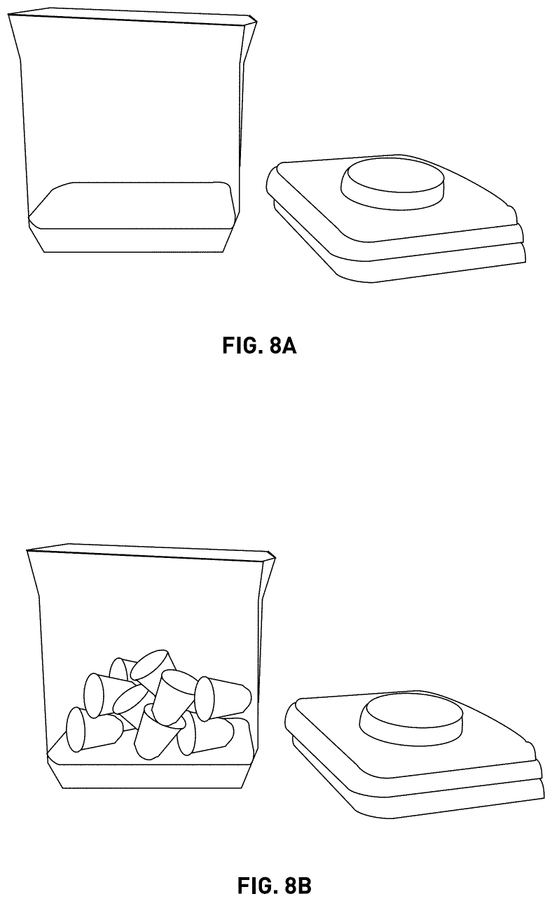

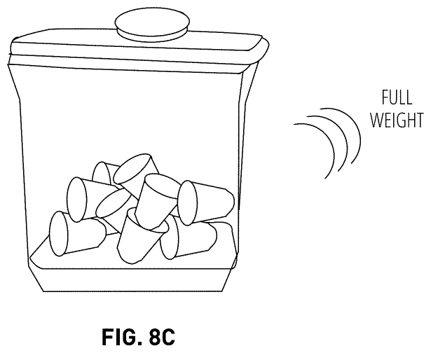

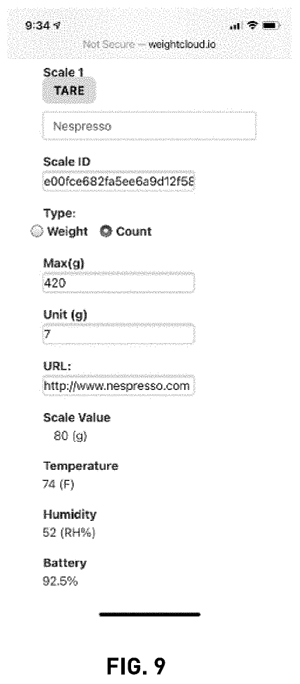

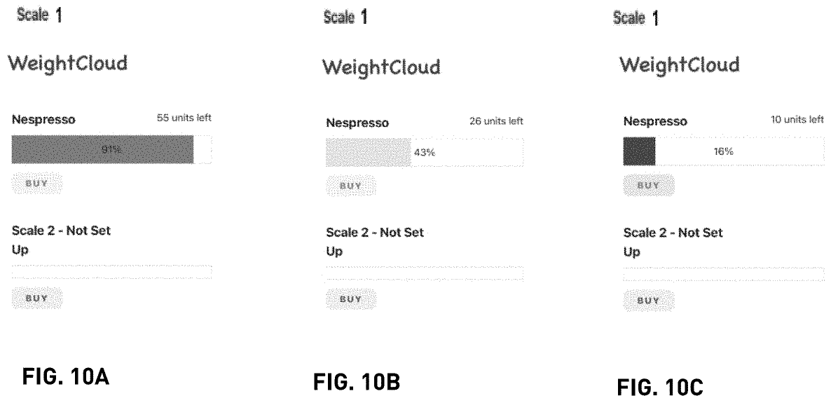

In one embodiment, as a mechanism for weight sensor calibration, when the container is full of product, the user may activate a control of the app (e.g., a “max” button) or on the container to calibrate (equate) a full container weight with a corresponding digital voltage value. The recorded value is set to be the point of reference for measuring and reporting product consumption. This process type of tare calibration is effectively the inverse of a typical tare scale calibration, which is performed under a zero container content load. See for example FIG. 8A-FIG. 8C. An exemplary control interface on an app for calibrating to a fully-loaded container weight is depicted in FIG. 9. The unit inventory is then tracked based on changes in the unit weight, as per for example the app interface depicted in FIG. 10A-FIG. 10C.

In one embodiment, the inverse tare calibration may be triggered automatically based on an increase in load weight detected by the container. For example, in the depiction of FIG. 9, the system may detect a sudden and significant (e.g., exceeding a threshold level) increase in loaded weight, and may then auto-calibrate to the new weight as the (fully loaded) tare weight. In some embodiments, the system may prompt the user to confirm that the increase in weight is due to fully reloading the container. Inventory depletion, and reorder triggering, may be based on the fully-loaded weight and unit weight as before.

In some implementations the product may be shipped to the consumer in the container with weight sensing, pre-calibrated to “full” settings. Container weights may be measured in real-time as inventory is removed, or periodically (e.g., once each night after business hours or when people are asleep if implemented in the home).

Sensors on the containers may tend to drift out of calibration. These drifts may be erroneously recorded as actual weight changes, hence actual inventory depletion. To mitigate such calibration drift errors on inventory tracking, the system may utilize sound, motion, or vibration sensors (for example) to detect the presence of a person in conjunction with a change in weight in one or more containers. These sensors may be integral with or positioned on the container, or one or more such sensors (e.g., wall or shelf-mounted) may be utilized by all containers in a given storage space. A positive detection of a person coextensive with a weight change may be recorded as an actual inventory change (depletion) with higher confidence than if the change occurs with no human being detected as present. In some embodiments, an additional or alternative motion control to apply to activation of weight/inventory updates is detection of manipulation of a lid of the container (e.g., an electrical contact to detect engagement between the lid and the container). For example if the lid has been removed and/or replaced coextensive in time with a change in weight, the confidence in the credence of the weight update may be increased. On condition that presence of a person is not detected but the weight sensor setting changes, the system may associate the changed setting with an existing setting for the level of inventory in the container (e.g., a certain number of grams, ounces, or units). Also, a drastic weight change (e.g., exceeding 50% of the inventory level setting for the container), absent detection of a person co-local with the container, may trigger generation of an alert to the user, as opposed to an automatic reorder. Such a circumstance may indicate the container was tipped over by an animal or large vibration, or structural failure of a shelf, for example.

Thus, a level of detected vibration consistent with the presence of a person may be enabling of an inventory level update, whereas a level of vibration consistent with a structural failure or structural disruption may trigger suppression of an inventory level update. The threshold vibration levels for each of these conditions may be configurable as settings in the system and may depend on storage environment factors for the containers (e.g., levels of ambient vibration or ambient vibration ranges).

Smaller changes in detected weight, especially small downward changes, may be put in abeyance before the system commits these changes to represent actual inventory changes. Such changes may, after a configured interval, turn out to be transient and due to environmental factors such as temperature changes in the area where the container is stored.

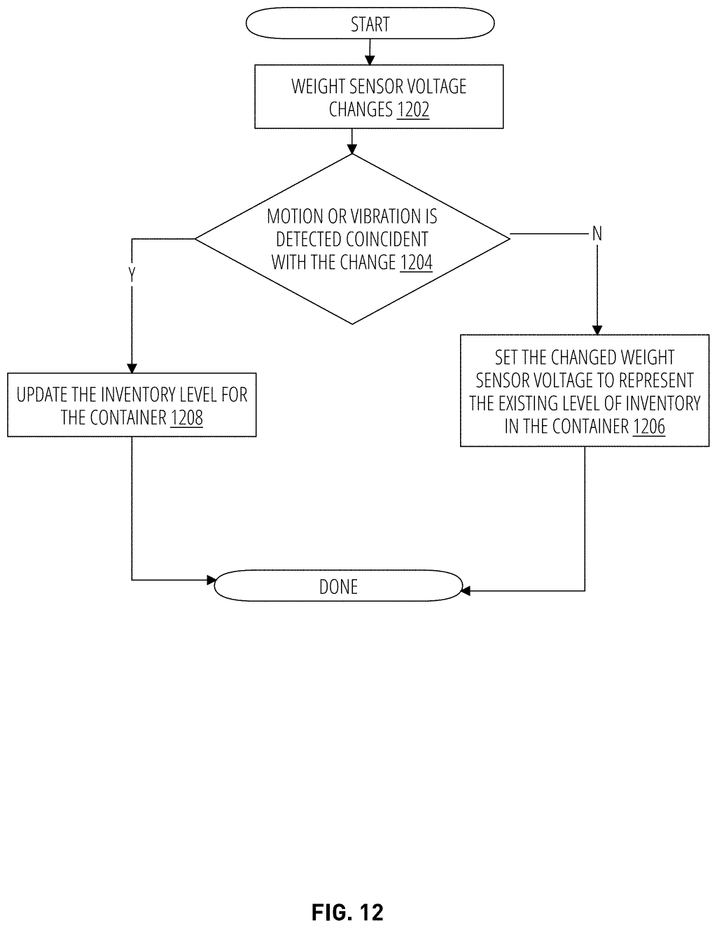

FIG. 12 depicts such a process. In the event that the weight sensor voltage changes 1202, if motion or vibration is detected coincident with the change 1204, update the inventory level for the container 1208. Otherwise, the set the changed weight sensor voltage to represent the existing level of inventory in the container 1206. A common component for detecting vibration is an accelerometer.

Referring again to FIG. 7A-FIG. 7C and to FIG. 10A-FIG. 10C, the process described above may result in suppression of activation of the “BUY” control on the control interface of the user's app or application, even though the “BUY” inventory level condition is satisfied.

To enable caloric tracking, the system may store or access (e.g., via the web) calorie content per gram or ounce. Likewise, the system may store or access ingredients of the contents of individual containers, to track the consumption of particular ingredients (fillers, artificial sweeteners, preservatives etc.) along similar vectors as described for calories. The system may interface with dieting apps or applications via an API to provide these tracking metrics.

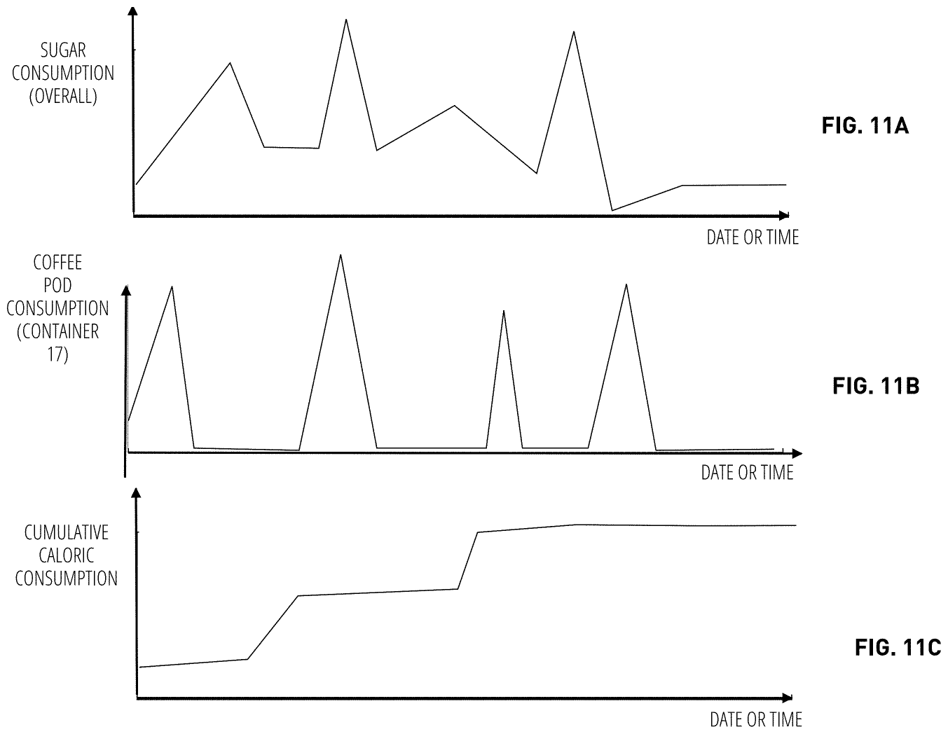

In one embodiment, when the contents of a container are identified as edible (e.g., with a configuration setting), the system maintains a running calculation of calories consumed from that container individually, or from all containers including edibles. The accumulated calorie count may be maintained along a number of possible vectors, including time intervals, types of consumables (sugars, fats, proteins, starches etc.), or combinations of these. Caloric consumption may also be tracked by rate of consumption, or along a time scale. See for example FIG. 11A-FIG. 11C.

In one embodiment, particular containers (and by association, particular edibles) may be associated with particular individuals in the system, e.g., configured via the app as settings on a server system for a particular user's account. For example certain containers may be associated with edibles for a particular pet or pets (e.g., dog food, cat food), or with edibles for only certain identified persons (e.g., diabetics, people with gluten allergies). Configuring associations between individuals and particular containers in the system enables calorie consumption tracking on a per-individual (people, animals) basis. A natural extension of this feature is configuring containers to be associated with groups of individuals (children, elderly, people on particular diets etc.). In one embodiment, when the system detects a depletion in weight of a container, or specifically-configured containers for this purpose, the app prompts the user to select an identifier of a person to which to allocate the calories for that depletion.

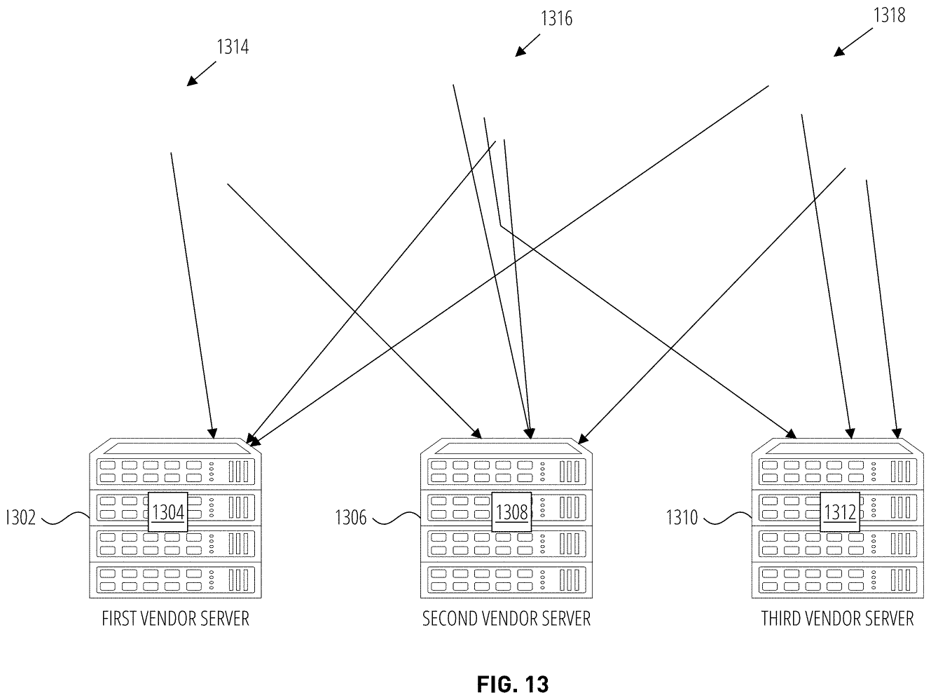

FIG. 13 depicts an embodiment of a system for automated inventory management, utilizing embodiments of the apparatuses and techniques disclosed herein. The system comprises a first vendor server 1302 comprising a reorder service 1304, a second vendor server 1306 comprising a reorder service 1308, and a third vendor server 1310 comprising a reorder service 1312. These services are responsive to signals from a first customer inventory 1314, a second customer inventory 1316, and a third customer inventory 1318.

Each of the customer inventories comprises a plurality of containers and each container holds a product. The set of the containers in the first customer inventory 1314 are assigned to a first customer, the second set of the containers in the second customer inventory 1316 is assigned to a second customer, and the third set of containers in the third customer inventory 1318 is assigned to a third customer. This assignment may be configured in logic of the containers themselves (e.g., by including a setting in the container logic for a customer identifier), or may be made at the vendor servers, e.g., by associating a container id with a customer id. Each container is also correlated with a vendor, in similar fashion.

In manners as previously described, the system may track an amount of each product remaining in each container based on an output of a weight sensors for the container. Based on output of a motion sensor, a reorder of a product in a container may be selectively activated at one of the vendor systems corresponding to the identify of the vendor associated with the container, on condition that a level of the particular one of the products as indicated by the output of the weight sensor for the corresponding container of the particular one of the products satisfies a threshold level configured for the particular one of the products. The reordered product is directed to the customer associated with the container.

The motion sensor may be a sensor indicating the container itself is in motion, in which case the reorder may be suppressed. Or, the motion sensor may be a sensor indicating motion proximate to or on the container, in which case the reorder may be enabled.

### Software Implementations

The systems disclosed herein, or particular components thereof, may in some embodiments be implemented as software comprising instructions executed on one or more programmable device. By way of example, components of the disclosed systems may be implemented as an application, an app, drivers, or services. In one particular embodiment, the system is implemented as a service that executes as one or more processes, modules, subroutines, or tasks on a server device so as to provide the described capabilities to one or more client devices over a network. However the system need not necessarily be accessed over a network and could, in some embodiments, be implemented by one or more app or applications on a single device or distributed between a mobile device and a computer, for example.

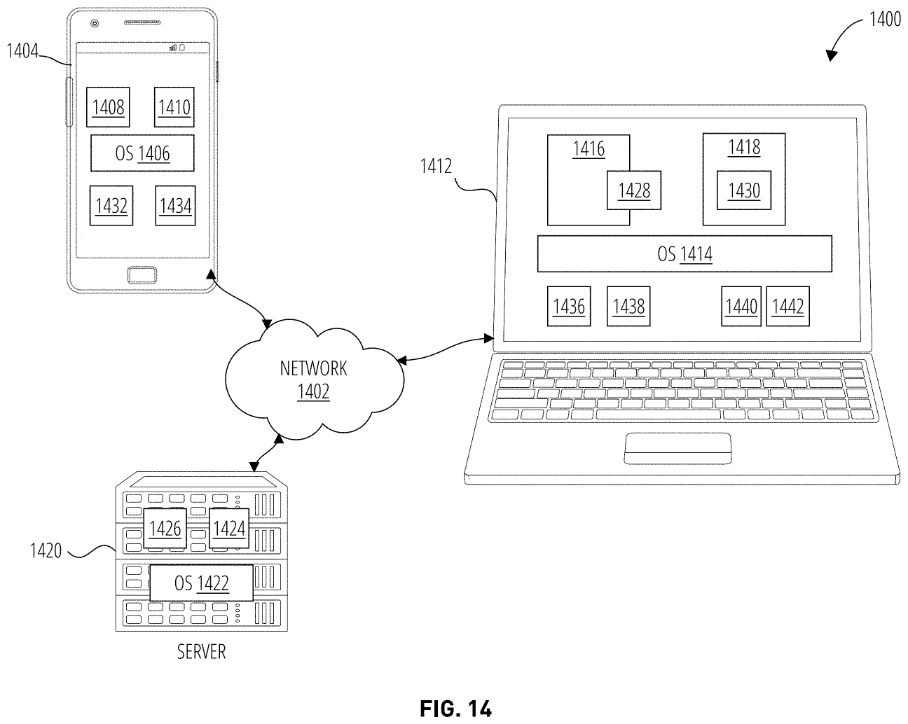

Referring to FIG. 14, a client server network configuration 1400 illustrates various computer hardware devices and software modules coupled by a network 1402 in one embodiment. Each device includes a native operating system, typically pre-installed on its non-volatile RAM, and a variety of software applications or apps for performing various functions.

The mobile programmable device 1404 comprises a native operating system 1406 and various apps (e.g., app 1408 and app 1410). A computer 1412 also includes an operating system 1414 that may include one or more library of native routines to run executable software on that device. The computer 1412 also includes various executable applications (e.g., application 1416 and application 1418). The mobile programmable device 1404 and computer 1412 are configured as clients on the network 1402. A server 1420 is also provided and includes an operating system 1422 with native routines specific to providing a service (e.g., service 1424 and service 1426) available to the networked clients in this configuration.

In one embodiment, to enable caloric tracking, the system may store or access (e.g., via the web) calorie content per gram or ounce on the server 1420. Likewise, the system may store on or access from the server 1420 ingredients of the contents of individual containers, to track the consumption of particular ingredients (fillers, artificial sweeteners, preservatives etc.) along similar vectors as described for calories. The system may interface with dieting apps (e.g, app 1408) or applications (e.g., application 1416) via an application program interface (API), plug-in 1428, or other mechanism known in the art, to provide these tracking metrics.

In some implementations the product may be shipped to the consumer in the container with weight sensing, pre-calibrated by a service 1426 of the server 1420 to “full” settings. Container weights may be measured by the service 1426 in real-time as inventory is removed, or periodically (e.g., once each night after business hours or when people are asleep if implemented in the home).

The service 1426 may be accessed by a consumable vendor (e.g., a coffee pod vendor) to track and report on consumption across many geographically dispersed and distinct customers. In one embodiment, the vendor may automatically reorder depleted inventory provided by the vendor on behalf of customers, in some cases after prompting the customers to confirm the reorder.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. Computer programs often implement mathematical functions or algorithms and may implement or utilize one or more application program interfaces.

A compiler is typically used to transform source code into object code and thereafter a linker combines object code files into an executable application, recognized by those skilled in the art as an “executable”. The distinct file comprising the executable would then be available for use by the computer 1412, mobile programmable device 1404, and/or server 1420. Any of these devices may employ a loader to place the executable and any associated library in memory for execution. The operating system executes the program by passing control to the loaded program code, creating a task or process. An alternate means of executing an application or app involves the use of an interpreter (e.g., interpreter 1430).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 1432 or driver 1434 on the mobile programmable device 1404 or computer 1412 (e.g., driver 1436 and driver 1438) might enable wireless headphones to be used for audio output(s) and a camera to be used for video inputs. Any of the devices may read and write data from and to files (e.g,. file 1440 or file 1442) and applications or apps may utilize one or more plug-in (e.g., plug-in 1428) to extend their capabilities (e.g., to encode or decode video files).

The network 1402 in the client server network configuration 1400 can be of a type understood by those skilled in the art, including a Local Area Network (LAN), Wide Area Network (WAN), Transmission Communication Protocol/Internet Protocol (TCP/IP) network, and so forth. These protocols used by the network 1402 dictate the mechanisms by which data is exchanged between devices.

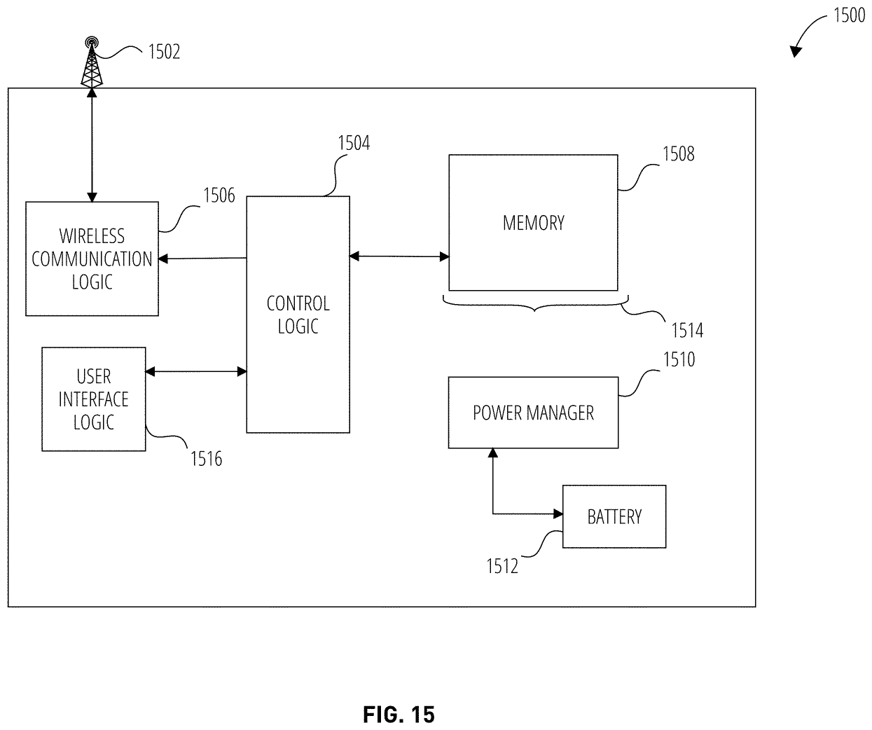

Referring to FIG. 15, a mobile device 1500 that may be utilized as the user device 116 executing the user device application 122 comprises an antenna 1502, control logic 1504, wireless communication logic 1506, a memory 1508, a power manager 1510, a battery 1512, logic 1514, and user interface logic 1516.

The control logic 1504 controls and coordinates the operation of other components as well as providing signal processing for the mobile device 1500. For example control logic 1504 may extract baseband signals from radio frequency signals received from the wireless communication logic 1506 logic, and processes baseband signals up to radio frequency signals for communications transmitted to the wireless communication logic 1506 logic. Control logic 1504 may comprise a central processing unit, digital signal processor, and/or one or more controllers or combinations of these components.

The wireless communication logic 1506 may further comprise memory 1508 which may be utilized by the control logic 1504 to read and write instructions (commands) and data (operands for the instructions). The memory 1508 may comprise logic 1514 to carry out aspects of the processes disclosed herein, e.g., those aspects executed by a smart phone or other mobile device.

A human user or operator of the mobile device 1500 may utilize the user interface logic 1516 to receive information from and input information to the mobile device 1500. Images, video and other display information, for example, user interface optical patterns, may be output to the user interface logic 1516, which may for example operate as a liquid crystal display or may utilize other optical output technology technology such as organic light emitting diodes (OLED). The user interface logic 1516 may also operate as a user input device, being touch sensitive where contact or close contact by a use's finger or other device handled by the user may be detected by transducers. An area of contact or proximity to the user interface logic 1516 may also be detected by transducers and this information may be supplied to the control logic 1504 to affect the internal operation of the mobile device 1500 and to influence control and operation of its various components.

Audio signals may be provided to user interface logic 1516 from which signals output to one and more speakers to create pressure waves in the external environment representing the audio. The mobile device 1500 may convert audio phenomenon from the environment into internal electro or optical signals by operating a microphone and audio circuit (not illustrated).

The mobile device 1500 may operate on power received from a battery 1512. The battery 1512 capability and energy supply may be managed by a power manager 1510.

The mobile device 1500 may transmit wireless signals of various types and range (e.g., cellular, GPS, WIFI, BlueTooth, and near field communication i.e. NFC). The mobile device 1500 may also receive these types of wireless signals. Wireless signals are transmitted and received using wireless communication logic 1506 logic coupled to one or more antenna 1502. Other forms of electromagnetic radiation may be used to interact with proximate devices, such as infrared (not illustrated).

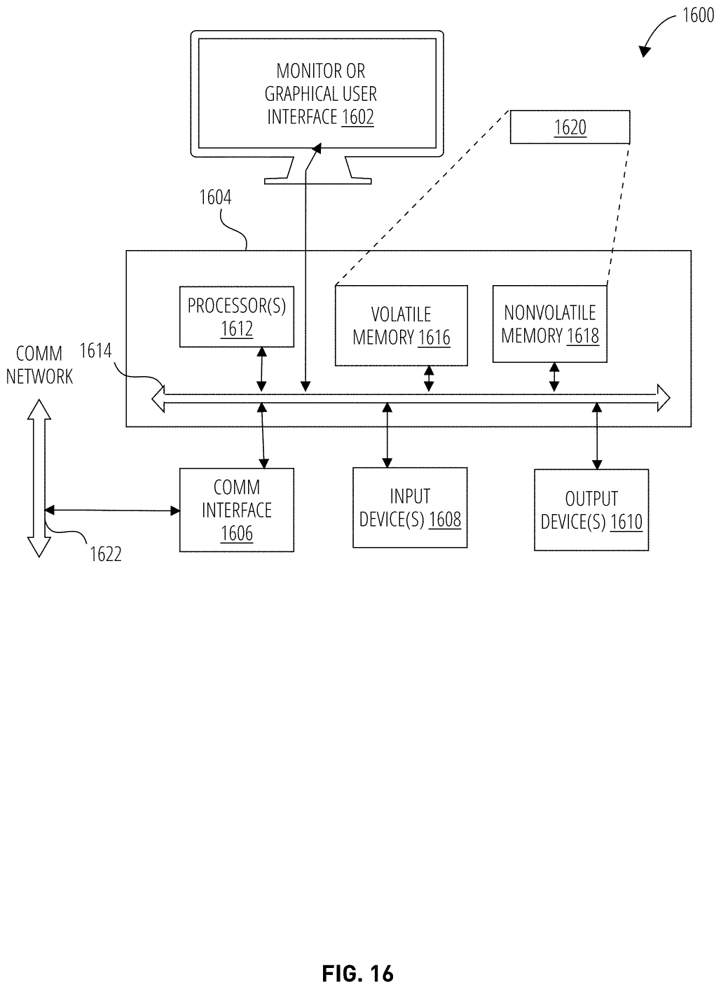

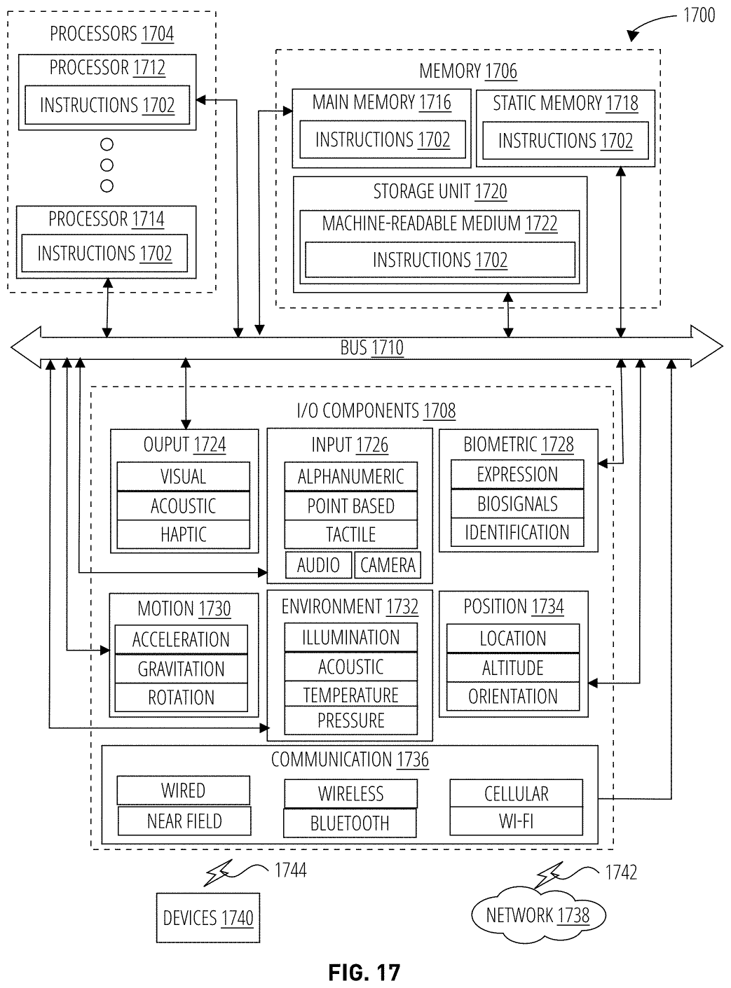

FIG. 16 is an example of a computing device 1600 that may incorporate embodiments of the present invention, such as the server application 124 or in some cases the user device application 122 when the user doesn't have a mobile device. FIG. 16 is merely illustrative of a machine system to carry out aspects of the technical processes described herein, and does not limit the scope of the claims. One of ordinary skill in the art would recognize other variations, modifications, and alternatives. In one embodiment, the computing device 1600 typically includes a monitor or graphical user interface 1602, a data processing system 1604, a communication network interface 1606, input device(s) 1608, output device(s) 1610, and the like. Another embodiment of such a device is depicted in FIG. 17.

As depicted in FIG. 16, the data processing system 1604 may include one or more processor(s) 1612 that communicate with a number of peripheral devices via a bus subsystem 1614. These peripheral devices may include input device(s) 1608, output device(s) 1610, communication network interface 1606, and a storage subsystem, such as a volatile memory 1616 and a nonvolatile memory 1618.

The volatile memory 1616 and/or the nonvolatile memory 1618 may store computer-executable instructions and thus forming logic 1620 that when applied to and executed by the processor(s) 1612 implement embodiments of the processes disclosed herein.

The input device(s) 1608 include devices and mechanisms for inputting information to the data processing system 1604. These may include a keyboard, a keypad, a touch screen incorporated into the monitor or graphical user interface 1602, audio input devices such as voice recognition systems, microphones, and other types of input devices. In various embodiments, the input device(s) 1608 may be embodied as a computer mouse, a trackball, a track pad, a joystick, wireless remote, drawing tablet, voice command system, eye tracking system, and the like. The input device(s) 1608 typically allow a user to select objects, icons, control areas, text and the like that appear on the monitor or graphical user interface 1602 via a command such as a click of a button or the like.

The output device(s) 1610 include devices and mechanisms for outputting information from the data processing system 1604. These may include the monitor or graphical user interface 1602, speakers, printers, infrared LEDs, and so on as well understood in the art.

The communication network interface 1606 provides an interface to communication networks (e.g., communication network 1622) and devices external to the data processing system 1604. The communication network interface 1606 may serve as an interface for receiving data from and transmitting data to other systems. Embodiments of the communication network interface 1606 may include an Ethernet interface, a modem (telephone, satellite, cable, ISDN), (asynchronous) digital subscriber line (DSL), FireWire, USB, a wireless communication interface such as Bluetooth or WIFI, a near field communication wireless interface, a cellular interface, and the like.

The communication network interface 1606 may be coupled to the communication network 1622 via an antenna, a cable, or the like. In some embodiments, the communication network interface 1606 may be physically integrated on a circuit board of the data processing system 1604, or in some cases may be implemented in software or firmware, such as “soft modems”, or the like.

The computing device 1600 may include logic that enables communications over a network using protocols such as HTTP, TCP/IP, RTP/RTSP, IPX, UDP and the like.

The volatile memory 1616 and the nonvolatile memory 1618 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1616 and the nonvolatile memory 1618 may be configured to store the basic programming and data constructs that provide the functionality of the disclosed processes and other embodiments thereof that fall within the scope of the present invention.

Logic 1620 that implements embodiments of the present invention may be stored in the volatile memory 1616 and/or the nonvolatile memory 1618. Said logic 1620 may be read from the volatile memory 1616 and/or nonvolatile memory 1618 and executed by the processor(s) 1612. The volatile memory 1616 and the nonvolatile memory 1618 may also provide a repository for storing data used by the logic 1620.

The volatile memory 1616 and the nonvolatile memory 1618 may include a number of memories including a main random access memory (RAM) for storage of instructions and data during program execution and a read only memory (ROM) in which read-only non-transitory instructions are stored. The volatile memory 1616 and the nonvolatile memory 1618 may include a file storage subsystem providing persistent (non-volatile) storage for program and data files. The volatile memory 1616 and the nonvolatile memory 1618 may include removable storage systems, such as removable flash memory.

The bus subsystem 1614 provides a mechanism for enabling the various components and subsystems of data processing system 1604 communicate with each other as intended. Although the communication network interface 1606 is depicted schematically as a single bus, some embodiments of the bus subsystem 1614 may utilize multiple distinct busses.

It will be readily apparent to one of ordinary skill in the art that the computing device 1600 may be a device such as a smartphone, a desktop computer, a laptop computer, a rack-mounted computer system, a computer server, or a tablet computer device. As commonly known in the art, the computing device 1600 may be implemented as a collection of multiple networked computing devices. Further, the computing device 1600 will typically include operating system logic (not illustrated) the types and nature of which are well known in the art.

FIG. 17 depicts a diagrammatic representation of a machine 1700 in the form of a computer system within which logic may be implemented to cause the machine to perform any one or more of the functions or methods disclosed herein, according to an example embodiment. For example the server 1420, computer 1412, and/or mobile programmable device 1404 may be implemented in accordance with the features of the machine 1700.

Specifically, FIG. 17 depicts a machine 1700 comprising instructions 1702 (e.g., a program, an application, an applet, an app, or other executable code) for causing the machine 1700 to perform any one or more of the functions or methods discussed herein. For example the instructions 1702 may cause the machine 1700 to carry out any of the aspects of inventory tracking and reordering disclosed herein, and/or the user interface and control aspects disclosed. The instructions 1702 configure a general, non-programmed machine into a particular machine 1700 programmed to carry out said functions and/or methods.

In alternative embodiments, the machine 1700 operates as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1702, sequentially or otherwise, that specify actions to be taken by the machine 1700. Further, while only a single machine 1700 is depicted, the term “machine” shall also be taken to include a collection of machines that individually or jointly execute the instructions 1702 to perform any one or more of the methodologies or subsets thereof discussed herein.

The machine 1700 may include processors 1704, memory 1706, and I/O components 1708, which may be configured to communicate with each other such as via one or more bus 1710. In an example embodiment, the processors 1704 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 1712 and processor 1714) to execute the instructions 1702. The term “processor” is intended to include multi-core processors that may comprise two or more independent processors (sometimes referred to as “cores”) that may execute instructions contemporaneously. Although FIG. 17 depicts multiple processors 1704, the machine 1700 may include a single processor with a single core, a single processor with multiple cores (e.g., a multi-core processor), multiple processors with a single core, multiple processors with multiples cores, or any combination thereof.

The memory 1706 may include one or more of a main memory 1716, a static memory 1718, and a storage unit 1720, each accessible to the processors 1704 such as via the bus 1710. The main memory 1716, the static memory 1718, and storage unit 1720 may be utilized, individually or in combination, to store the instructions 1702 embodying any one or more of the functionality described herein. The instructions 1702 may reside, completely or partially, within the main memory 1716, within the static memory 1718, within a machine-readable medium 1722 within the storage unit 1720, within at least one of the processors 1704 (e.g., within the processor's cache memory), or any suitable combination thereof, during execution thereof by the machine 1700.

The I/O components 1708 may include a wide variety of components to receive input, provide output, produce output, transmit information, exchange information, capture measurements, and so on. The specific I/O components 1708 that are included in a particular machine will depend on the type of machine. For example, portable machines such as mobile phones will likely include a touch input device or other such input mechanisms, while a headless server machine will likely not include such a touch input device. It will be appreciated that the I/O components 1708 may include many other components that are not shown in FIG. 17. The I/O components 1708 are grouped according to functionality merely for simplifying the following discussion and the grouping is in no way limiting. In various example embodiments, the I/O components 1708 may include output components 1724 and input components 1726. The output components 1724 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 1708 may include biometric components 1728, motion components 1730, environmental components 1732, or position components 1734, among a wide array of possibilities. For example, the biometric components 1728 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1730 may include acceleration sensor components (e.g., accelerometer), gravitation sensor components, rotation sensor components (e.g., gyroscope), and so forth. The environmental components 1732 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1734 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1708 may include communication components 1736 operable to couple the machine 1700 to a network 1738 or devices 1740 via a coupling 1742 and a coupling 1744, respectively. For example, the communication components 1736 may include a network interface component or another suitable device to interface with the network 1738. In further examples, the communication components 1736 may include wired communication components, wireless communication components, cellular communication components, Near Field Communication (NFC) components, Bluetooth® components (e.g., Bluetooth® Low Energy), WiFi® components, and other communication components (e.g., LoRaWAN) to provide communication via other modalities. The devices 1740 may be another machine or any of a wide variety of peripheral devices (e.g., a peripheral device coupled via a USB).

Moreover, the communication components 1736 may detect identifiers or include components operable to detect identifiers. For example, the communication components 1736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1736, such as location via Internet Protocol (IP) geolocation, location via Wi-Fi® signal triangulation, location via detecting an NFC beacon signal that may indicate a particular location, and so forth.

### Instruction and Data Storage Medium Embodiments

The various memories (i.e., memory 1706, main memory 1716, static memory 1718, and/or memory of the processors 1704) and/or storage unit 1720 may store one or more sets of instructions and data structures (e.g., software) embodying or utilized by any one or more of the methodologies or functions described herein. These instructions (e.g., the instructions 1702), when executed by processors 1704, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

Some aspects of the described subject matter may in some embodiments be implemented as computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular data structures in memory. The subject matter of this application may be practiced in a variety of system configurations, including hand-held devices, consumer electronics, general-purpose computers, more specialty computing devices, etc. The subject matter may also be practiced in distributed computing environments where tasks are performed by remote-processing devices that are linked through a communications network.

### Communication Network Embodiments

In various example embodiments, one or more portions of the network 1738 may be an ad hoc network, an intranet, an extranet, a VPN, a LAN, a WLAN, a WAN, a WWAN, a MAN, a LoRaWAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1738 or a portion of the network 1738 may include a wireless or cellular network, and the coupling 1742 may be a Code Division Multiple Access (CDMA) connection, a Global System for Mobile communications (GSM) connection, or another type of cellular or wireless coupling. In this example, the coupling 1742 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1702 and/or data generated by or received and processed by the instructions 1702 may be transmitted or received over the network 1738 using a transmission medium via a network interface device (e.g., a network interface component included in the communication components 1736) and utilizing any one of a number of well-known transfer protocols (e.g., hypertext transfer protocol (HTTP)). Similarly, the instructions 1702 may be transmitted or received using a transmission medium via the coupling 1744 (e.g., a peer-to-peer coupling) to the devices 1740. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1702 for execution by the machine 1700, and/or data generated by execution of the instructions 1702, and/or data to be operated on during execution of the instructions 1702, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### LISTING OF DRAWING ELEMENTS

100 system

102 product container

104 product

106 weight sensor

108 logic

110 temperature sensor

112 accelerometer

114 gyroscope

116 user device

118 network

120 server system

122 device application

124 server application

126 ecommerce system

128 search engine

130 vendor products

132 fulfillment service

202 propane tank

204 sensing system

206 valve

208 carry handle

210 tank base

212 base receptacle

214 stand

216 base retainer

218 code or near field device

220 reader

222 propane heat lamp

224 wheels

300 product reorder process

302 product database

304 container

306 triggering event

308 data packet

310 user device

312 network server

314 product SKU

316 product SKU

318 correlate the SKU to product data

320 product data

322 product data

324 execute the weight computation algorithm

326 prompt for the user to reorder

328 suppress reorders

330 reorder SKU

332 reorder SKU

334 ecommerce system

336 receipt

338 receipt

400 product reorder process

402 reorder signal

500 weight determination process

502 done block

504 block

506 decision block

508 block

600 product reordering process

602 done block

604 block

606 decision block

608 block

610 block

612 decision block

614 decision block

616 decision block

618 block

700 tracking and reordering system machine interface

702 tracking interface

704 vendor interface

706 vendor-specific order interface

708 purchase activation control

710 remaining indicator

712 depleted indicator

714 battery level indicator

716 full weight setting control

718 content filter controls

1202 weight sensor voltage changes

1204 motion or vibration is detected coincident with the change

1206 set the changed weight sensor voltage to represent the existing level of inventory in the container

1208 update the inventory level for the container

1302 first vendor server

1304 service

1306 second vendor server

1308 service

1310 third vendor server

1312 service

1314 first customer inventory

1316 second customer inventory

1318 third customer inventory

1400 client server network configuration

1402 network

1404 mobile programmable device

1406 operating system

1408 app

1410 app

1412 computer

1414 operating system

1416 application

1418 application

1420 server

1422 operating system

1424 service

1426 service

1428 plug-in

1430 interpreter

1432 driver

1434 driver

1436 driver

1438 driver

1440 file

1442 file

1500 mobile device

1502 antenna

1504 control logic

1506 wireless communication logic

1508 memory

1510 power manager

1512 battery

1514 logic

1516 user interface logic

1600 computing device

1602 monitor or graphical user interface

1604 data processing system

1606 communication network interface

1608 input device(s)

1610 output device(s)

1612 processor(s)

1614 bus subsystem

1616 volatile memory

1618 nonvolatile memory

1620 logic

1622 communication network

1700 machine

1702 instructions

1704 processors

1706 memory

1708 I/O components

1710 bus

1712 processor

1714 processor

1716 main memory

1718 static memory

1720 storage unit

1722 machine-readable medium

1724 output components

1726 input components

1728 biometric components

1730 motion components

1732 environmental components

1734 position components

1736 communication components

1738 network

1740 devices

1742 coupling

1744 coupling

Terms used herein should be accorded their ordinary meaning in the relevant arts, or the meaning indicated by their use in context, but if an express definition is provided, that meaning controls.

“Algorithm” refers to any set of instructions configured to cause a machine to carry out a particular function or process.

“App” refers to a type of application with limited functionality, most commonly associated with applications executed on mobile devices. Apps tend to have a more limited feature set and simpler user interface than applications as those terms are commonly understood in the art.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“Application program interface” refers to instructions implementing entry points and return values to a module.

“Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported.

“Compiled computer code” refers to object code or executable code derived by executing a source code compiler and/or subsequent tools such as a linker or loader.

“Compiler” refers to logic that transforms source code from a high-level programming language into object code or in some cases, into executable code.

“Computer code” refers to any of source code, object code, or executable code.

“Computer code section” refers to one or more instructions.

“Computer program” refers to another term for ‘application’ or ‘app’.

“Driver” refers to low-level logic, typically software, that controls components of a device. Drivers often control the interface between an operating system or application and input/output components or peripherals of a device, for example.

“Executable” refers to a file comprising executable code. If the executable code is not interpreted computer code, a loader is typically used to load the executable for execution by a programmable device.

“Executable code” refers to instructions in a ready-to-execute form by a programmable device. For example, source code instructions in non-interpreted execution environments are not executable code because they must usually first undergo compilation, linking, and loading by the operating system before they have the proper form for execution. Interpreted computer code may be considered executable code because it can be directly applied to a programmable device (an interpreter) for execution, even though the interpreter itself may further transform the interpreted computer code into machine language instructions.

“File” refers to a unitary package for storing, retrieving, and communicating data and/or instructions. A file is distinguished from other types of packaging by having associated management metadata utilized by the operating system to identify, characterize, and access the file.

“Instructions” refers to symbols representing commands for execution by a device using a processor, microprocessor, controller, interpreter, or other programmable logic. Broadly, ‘instructions’ can mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Interpreted computer code” refers to instructions in a form suitable for execution by an interpreter.

“Interpreter” refers to an interpreter is logic that directly executes instructions written in a source code scripting language, without requiring the instructions to a priori be compiled into machine language. An interpreter translates the instructions into another form, for example into machine language, or into calls to internal functions and/or calls to functions in other software modules.

“Library” refers to a collection of modules organized such that the functionality of all the modules may be included for use by software using references to the library in source code.

“Linker” refers to logic that inputs one or more object code files generated by a compiler or an assembler and combines them into a single executable, library, or other unified object code output. One implementation of a linker directs its output directly to machine memory as executable code (performing the function of a loader as well).

“Loader” refers to logic for loading programs and libraries. The loader is typically implemented by the operating system. A typical loader copies an executable into memory and prepares it for execution by performing certain transformations, such as on memory addresses.

“Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Machine language” refers to instructions in a form that is directly executable by a programmable device without further translation by a compiler, interpreter, or assembler. In digital devices, machine language instructions are typically sequences of ones and zeros.

“Module” refers to a computer code section having defined entry and exit points. Examples of modules are any software comprising an application program interface, drivers, libraries, functions, and subroutines.

“Object code” refers to the computer code output by a compiler or as an intermediate output of an interpreter. Object code often takes the form of machine language or an intermediate language such as register transfer language (RTL).

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Plug-in” refers to software that adds features to an existing computer program without rebuilding (e.g., changing or re-compiling) the computer program. Plug-ins are commonly used for example with Internet browser applications.

“Process” refers to software that is in the process of being executed on a device.

“Programmable device” refers to any logic (including hardware and software logic) who's operational behavior is configurable with instructions.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Software” refers to logic implemented as instructions for controlling a programmable device or component of a device (e.g., a programmable processor, controller). Software can be source code, object code, executable code, machine language code. Unless otherwise indicated by context, software shall be understood to mean the embodiment of said code in a machine memory or hardware component, including “firmware” and micro-code.

“Source code” refers to a high-level textual computer language that requires either interpretation or compilation in order to be executed by a device.

“Subroutine” refers to a module configured to perform one or more calculations or other processes. In some contexts the term ‘subroutine’ refers to a module that does not return a value to the logic that invokes it, whereas a ‘function’ returns a value. However herein the term ‘subroutine’ is used synonymously with ‘function’.

“Task” refers to one or more operations that a process performs.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A system comprising:
a plurality of vendor systems;
a plurality of containers each comprising a product;
wherein a first set of the containers is assigned to a first customer and a second set of the containers is assigned to a second customer;
a sensor arrangement comprising at least a weight sensor for each container, and at least one motion sensor;
logic to:
correlate each container to an identify of a product in the container to determine a corresponding container for each product;
correlate each container to an identify of a customer associated with the container;
correlate each container to an identity of a vendor associated with the container;
track an amount of each product remaining in each container based on an output of the weight sensors; and
based on output of the motion sensor, selectively activate, at one of the vendor systems corresponding to the identify of the vendor associated with the container, a reorder for a particular one of the products, on condition that a level of the particular one of the products as indicated by the output of the weight sensor for a corresponding container of the particular one of the products satisfies a threshold level configured for the particular one of the products, the reorder directed to the customer associated with the container.

2. A system comprising:
a plurality of containers each comprising a product;
a sensor arrangement comprising at least a weight sensor for each container, and one or more motion sensors;
logic to:
correlate each container to an identify of a product in the container to determine a corresponding container for each product;
track an amount of each product remaining in each container based on an output of the weight sensor for the corresponding container for the product;
display, on an app or application of a user device, a control interface comprising tracking controls for each product, each tracking control comprising an indication of the amount of the product remaining in the corresponding container for the product, and a reorder control for the product;
determine motion in a location of the containers based on an output of the one or more motion sensors; and
selectively enable, on the control interface, the reorder control of one or more of the products, on condition that (a) the amount of the one or more products in the corresponding container satisfies a threshold level individually configured for each of the one or more products, and (b) the output of the one or more motion sensors comprises a motion threshold indicative of human activity near or on the corresponding container for the one or more products.

3. The system of claim 2, wherein each of the containers comprises at least one of the one or more motion sensors.

4. The system of claim 2, wherein the one or more motion sensors is separate from the containers.

5. The system of claim 2, further comprising:
logic to suppress a stored update to the amount of a product on condition that the motion threshold is not satisfied, when the output of the weight sensor for the corresponding container for the product indicates an amount of the product remaining in the container has changed.

6. The system of claim 2, further comprising:
a configured unit weight for each product; and
the logic to track the amount of each product applying the configured unit weight for each product to convert the output of the weight sensor to a change in unit count for the product.

7. The system of claim 2, wherein at least one of the containers is a propane tank.

8. The system of claim 7, further comprising a base unit separate from the propane tank, the base unit comprising the weight sensor.

9. The system of claim 2, wherein the logic to suppress activation of the reorder controls based on the output of the motion sensor comprises logic to suppress the activation on condition that the motion sensor does not detect motion of a person in the location of the containers.

10. The system of claim 2, wherein the logic to suppress activation of the reorder controls based on the output of the motion sensor comprises logic to suppress the activation on condition that the motion sensor does not detect removal of a lid of the container.

11. The system of claim 2, wherein the motion sensor comprises a vibration sensor and the configured motion threshold is a vibration threshold.

12. A container apparatus comprising:
a weight sensor and a motion sensor;
a product identifier for a product in the container;
logic to:
detect a changed weight of the product indicated by the weight sensor;
on condition that an output of the motion sensor does not meet or exceed a configured level, associate an existing recorded amount of the product in the container to the changed weight; and
otherwise communicating to an app or application of a user device an indication of the changed weight.

13. The container of claim 12, wherein the motion sensor comprises a vibration sensor; and
logic to communicate to the app or application the indication of the changed weight on condition that an output of the vibration sensor satisfies a configured vibration level.

14. The container of claim 12, further comprising:
a configured unit weight for the product;
logic to convert the changed weight to a change in a unit count for the product; and
the indication of the changed weight for the product comprising the change to the unit count.

15. The container of claim 12, wherein the container is a propane tank.

16. The container of claim 15, further comprising a base unit separate from the propane tank, the base unit comprising the weight sensor.

17. The container of claim 12, wherein the configured level is a level indicating human proximity to the container.

18. The container of claim 12, wherein the motion sensor is a sensor configured to detect manipulation of a lid of the container.

19. The container of claim 12, wherein the indication of the changed weight comprises a change in a total weight of the product in the container.

20. The container of claim 12, further comprising logic to:
associate the existing recorded amount of the product in the container to the changed weight on condition that the output of the motion sensor is less than a configured duration.
